(19) United States
(12) Patent Application Publication
(10) Pub. No.: US 2022/0298368 A1
(43) Pub. Date: Sep. 22, 2022

(54) SYSTEM AND METHOD FOR AN AQUEOUS STRUCTURAL COLOR FORMING SOLUTION

(71) Applicant: Cyprus Materials Inc., Berkeley, CA (US)

(72) Inventors: Matthew D. Ryan, Berkeley, CA (US); Ryan M. Pearson, Berkeley, CA (US); Alexander Hess, Oakland, CA (US); Luke Whitson, Oakland, CA (US)

(21) Appl. No.: 17/698,510

(22) Filed: Mar. 18, 2022

Related U.S. Application Data
(60) Provisional application No. 63/162,785, filed on Mar. 18, 2021.

(51) Int. Cl. C09D 11/033; C09D 11/037; C09D 11/14; C09D 11/106; C09D 11/322; B41M 7/00

(52) U.S. Cl. CPC C09D 11/033; C09D 11/037; C09D 11/14; C09D 11/106; C09D 11/322; B41M 7/0018

(57) ABSTRACT

A system and method for production and implementation of a photonic crystal forming, aqueous solution, may include: a block polymer mixture and at least one solvent, wherein the at least one solvent comprises water. The “color” of the photonic crystal solution may be set either through a single, or multiple, brush block copolymer mixtures (i.e., premixed coloring) or through layering of multiple layers of distinct single, or multiple, brush block copolymer mixtures. The system functions as an aqueous structural color (i.e., a photonic crystal) precursor, wherein applying the water-based color solution to a substrate, functions to provide a desired photonic crystal object arrangement possessing color reflective properties.

### CROSS-REFERENCE TO RELATED APPLICATIONS

This application claims the benefit of U.S. Provisional Application No. 63/162,785, filed on 18 Mar. 2021, which is hereby incorporated in its entirety by this reference.

### TECHNICAL FIELD

This invention relates generally to the field of photonic crystal formation, and more specifically to a new and useful system and method for an aqueous photonic crystal forming solution.

### BACKGROUND

Color formation, particularly the creation of new colors for use, has been a field of development for thousands of years. Although research and development has been continuing for eons, the technology of color formation and its application has been mostly focused on developing new colors through the development of dyes and pigments.

Dyes are organic compounds that are typically extracted from plants or synthetically produced (e.g., indigo or alizarin). Dyes provide useful coloration, that may or may not be toxic, and are limited in variety of uses. Additionally, printing/applying dyes to substrates (e.g., garments) may require strong organic solvents that may be toxic and/or volatile. Pigments are dry coloring matter, usually insoluble particles mixed with solvents, and can be derived from coal tars and petrochemicals. Pigments provide a much broader variation of colors, as compared to dyes, but tend to be more toxic or difficult to formulate with.

Dyes and pigments thus suffer from many limitations, including but not limited to: cradle to cradle environmental footprint, achievable color gamut, ease of manufacturing, and ease of application. For example, dyes and pigments are limited by having to find and create new stabilization chemistries for each color formulation produced. Many dyes and pigments are potentially toxic, which may include danger in both upstream manufacturing processes to downstream end-uses and their end-of-life disposal. Articles colored with dyes or pigments tend to fade over time, a problem known as color fastness, as the dye or pigment slowly disperses and degrades (e.g., the chromophore that gives rise to color may oxidize) over time. Additionally, effect pigments (also referred to as interference pigments) comprise particles that are comparatively large, limiting their utilization for printing, particularly inkjet printing, or broadly any application that requires fine atomization of paint or inks or the passage of paint or inks through small pores during application. Finally, because of the stringent requirements on solubility and particle size for application, the ability to easily disperse the colorant can pose issue. The above issues also pertain to compounds that interact with non-visible light energies such as ultraviolet and near infrared.

Thus, there is a need in the fields of color formation, reflective material formation, and color applications such as spray (e.g., automotive paints), brush (e.g., architectural paints), and print application for a more consistent way of color formation for all uses that is non-toxic/low-volatile, is not limited by creating or finding new chromophores, is simple to formulate, has unique optical properties, and does not fade over time. This invention provides such a new and useful system and method.

### BRIEF DESCRIPTION OF THE FIGURES

FIG. 1 is an illustration of typically implemented color gamuts.

FIG. 2 is a list of formulations for example system color solutions with high water content.

FIG. 3 is a plot of the reflective property of the example system color solutions with high water content.

FIG. 4 is a chart of the color formulations for the example color solutions with high water content.

FIG. 5 is a list of formulations for example system color solutions with amphipathic solvents.

FIG. 6 is a plot of the reflective property of the example system color solutions with amphipathic solvents.

FIG. 7 is a chart of the color formulations for the example color solutions with amphipathic solvents.

FIG. 8 is a list of formulations for example system color solutions with curable monomers.

FIG. 9 is a plot of the reflective property of the example system color solutions with curable monomers.

FIG. 10 is a chart of the color formulations for the example color solutions with curable monomers.

FIG. 11 is a formulation for an example system color solution with a Joncryl 537 additive.

FIG. 12 is a plot of the reflective property of the example system color solution with Joncryl 537 additive.

FIG. 13 is a chart of the color formulation for the example color solutions with Joncryl 537 additive.

FIG. 14 is a list of formulations for example system color solutions with water miscible solvents.

FIG. 15 is a plot of the reflective property of the example system color solutions with water miscible solvents.

FIG. 16 is a chart of the color formulations for the example color solutions with water miscible solvents.

FIG. 17 is a list of formulations for example system color solutions with an amphipathic solvent and no surfactant.

FIGS. 18-19 are plots of the reflective property of the example system color solutions with an amphipathic solvent and no surfactant.

FIG. 20 is a list of formulations for example system color solutions with a surfactant.

FIGS. 21-22 are plots of the reflective property of the example system color solutions with a surfactant.

FIG. 23 is a second list of formulations for example system color solutions with a surfactant.

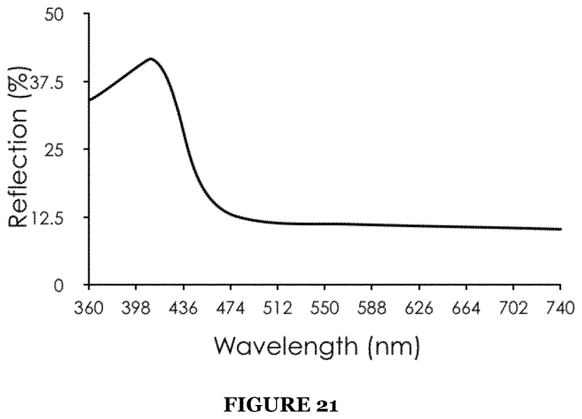

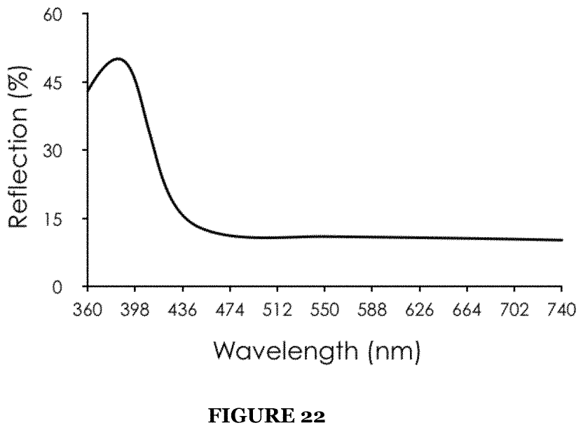

FIGS. 21-22 are plots of the reflective property of the example system color solutions with a surfactant.

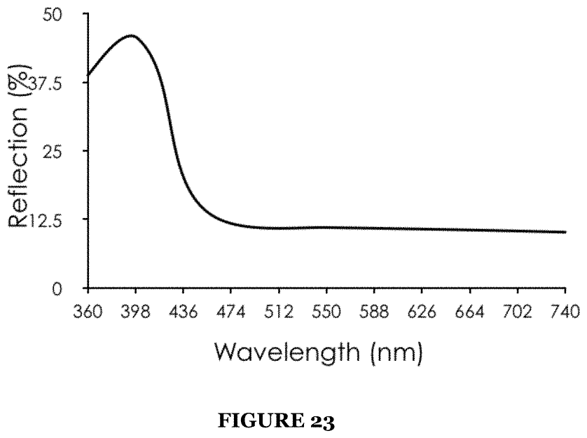

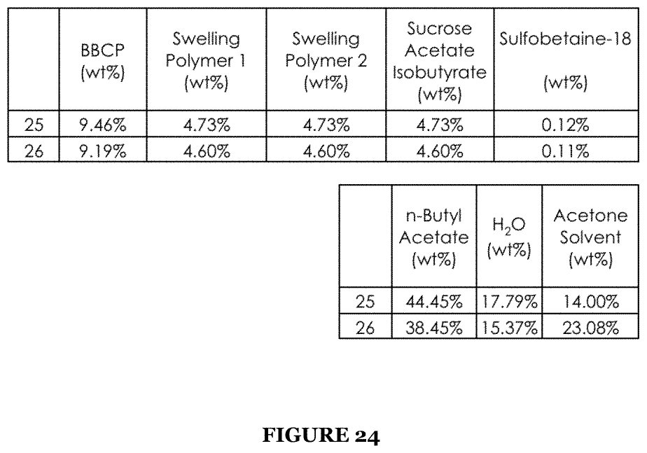

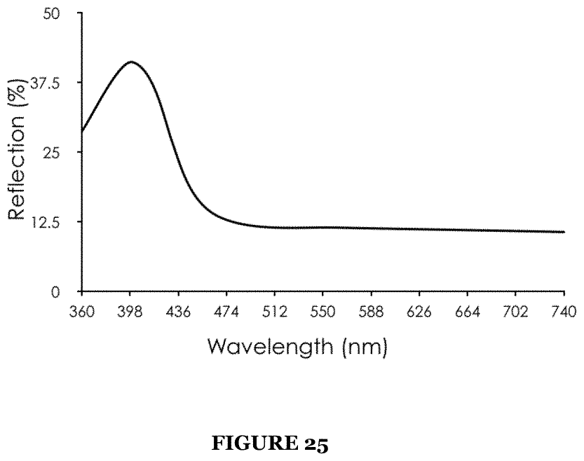

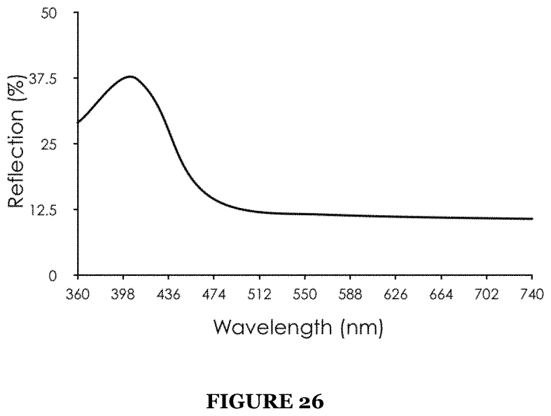

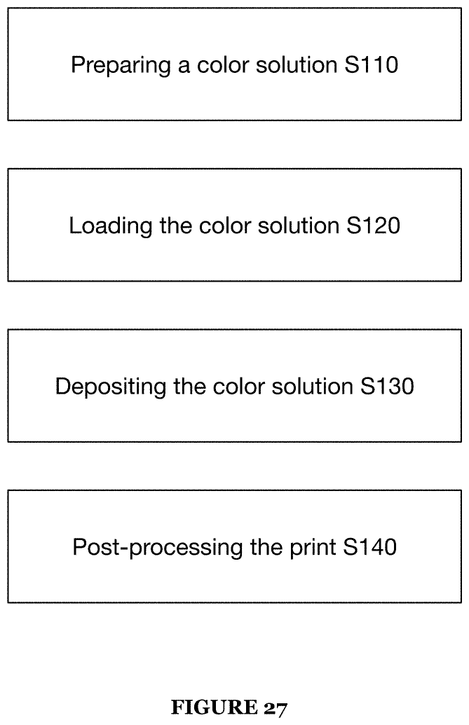

FIG. 23 is a flow chart of a sample method.

### DESCRIPTION OF THE EMBODIMENTS

The following description of the embodiments of the invention is not intended to limit the invention to these embodiments but rather to enable a person skilled in the art to make and use this invention.

### 1. Overview

A system and method for production and implementation of a photonic crystal forming, aqueous solution, may include: a block polymer mixture and at least one solvent, wherein the at least one solvent comprises water. The “color” of the photonic crystal solution may be set either through a single, or multiple, brush block copolymer mixtures (i.e., premixed coloring) or through layering of multiple layers of distinct single, or multiple, brush block copolymer mixtures. The system functions as an aqueous structural color (i.e., a photonic crystal) precursor, wherein applying the color solution to a substrate, functions to provide a desired photonic crystal object arrangement possessing color reflective properties. Dependent on implementation, the deposited photonic crystal arrangement may have light reflective properties ranging anywhere on the electromagnetic spectrum, thus including the visible, ultraviolet, and infrared spectra.

The system and method may be applied in any field or application that requires reflective inks or coatings. As a water containing solution that may be less toxic to biological matter, the system and method may indeed provide a large and diverse panoply of uses. General fields that require high end colorants, such as cosmetics, printing, painting (architectural and artistic paints), packaging, and automotives, may find the system and method particularly useful. The system and method may be implemented for any coloring and/or printing application. The system and method may also be particularly suited for biological sensitive uses. These may include facial (and other sensitive area) cosmetics, foods (e.g., food coloring), and architectural paints (e.g., for residential buildings). The system and method may additionally be implemented for types of printing, including, but not limited to: ink jet printing, screen printing, thermal printing, flexographic printing, and roto-gravure printing.

The system and method may be used for thermal management. As the goal of the system and method is to create and apply a reflective coating. The color and arrangement of the coating may be leveraged to provide the potential benefit of improved thermal management (e.g., for a building or vehicle).

The system and method, enable production of designs beyond the visible spectrum, particularly into the ultraviolet and infrared spectra. This may provide the potential benefit of non-visible signaling.

The system and method may provide a number of potential benefits. Ultra-violet, visible, and/or near infrared reflective coatings created through photonic crystal forming inks may be significantly less toxic as compared to currently used pigments and dyes.

With the implementation of a water solvent, or cosolvent, the system and method may additionally provide the benefit of being more useful for biological use, consumption, and exposure. That is, the ultra-violet, visible, and/or near infrared reflective coating formulation may potentially be less of an irritant, on, near, or consumed, by humans (and other living creatures) as compared to pure oil based, pure solvent based, and other types of ultra-violet, visible, and/or near infrared reflective coating formulations.

The system and method may enable a diverse set of new implementations and applications for color implementation. Additionally, the system and method may provide a ultra-violet, visible, and/or near infrared reflective coating solution that is still usable with previously existing structural coloring solutions. For example, the system and method may provide a unique reflective coating implementation that is still usable with current implementations (e.g., through the use of microfluidic-generated self-assembled photonic microspheres).

Additionally, the photonic crystal forming reflective coating solution may provide a more “resilient” form of color that is less susceptible to fading as compared to conventional pigments and dyes.

Additionally, the photonic crystal forming color solution may provide a more unique form of reflective properties that possesses unique angle-dependent appearances, which could be valuable for automotive, security markings, and packaging.

For certain applications, the angle-dependent nature of the reflective coating (i.e., different colors or wavelengths of light are observed by the viewer as the viewing angle, or angle of incident light, is modulated), or lack thereof, may be a valuable property. Due to their structure, interference pigments create angle-dependent coloration, often referred to as “iridescence” or “color flop”. Interference pigments may be used as additives for automotive coatings, packaging, and/or other uses. One potential difference between effect pigments and the system and method is that the system and method may form angle dependent reflective (or non-angle dependent reflective) structures after deposition onto a substrate.

For printing and painting, the system and method may enable application of polymeric molecules of higher molecular weight, or “larger”, than currently used. That is, brush block copolymers may provide lower solution viscosity and increased shear thinning properties as compared to linear block copolymers of similar molecular weight, that enable application of “larger” polymers. This may be in the form of printing (e.g., with a printer), or spray painting.

The system and method may provide a cheaper and improved method of applying reflective materials as compared to current technologies. Through the use of a co-binder, the system and method may provide a significantly larger volume solution as compared to current products.

The system and method may provide a method of producing and applying an ultraviolet reflective coatings spanning, but not limited to, 200-400 nm wavelengths.

The system and method may provide a method of producing and applying a visible light reflective coatings spanning, but not limited to, 400-750 nm wavelengths.

The system and method may provide a method of producing and applying an infrared reflective coatings spanning, but not limited to, 750-2000 nm wavelengths.

The system and method may provide a method of printing new color gamuts as compared to current technologies. Through the use of additive mixing, the system and method may provide colors that cannot be achieved through currently available pigments, dyes, and generally through applications of subtractive mixing theories.

Additionally, the system and method may provide an enhancement with pigments and dyes. The system and method may enable a wider range of colors through combining photonic crystal forming ink with pigments and dyes to create a color gamut through a mix of subtractive and additive color mixing theories.

### 2. System

A composition for a photonic crystal forming aqueous solution may include: at least one block copolymer 110; and at least one solvent 120 comprising water. In many variations, the at least one solvent 120 may further comprise an organic solvent in addition to water. The composition functions as a non-particulate dispersion of block copolymer, that forms a reflective structure (i.e., structural color) once deposited onto a substrate. That is, the composition functions as a water-based block copolymer solution, that once applied to an applicable surface, dries to form a “film” with the appropriate thickness, color, and design, as determined by the method of application and desired implementation. In preferred variations, the formed photonic crystal structure has a relatively periodic nano-, or micro-, structure within the deposited film with an average periodicity appropriate to a desired color wavelength (or desired color wave band). Additionally, as an aqueous solution, the composition functions as an aqueous block polymer solution, the composition may function as a paint with reduced biological toxicity, particularly as compared to solvent-based dyes and pigments.

The composition may vary greatly dependent on implementation (e.g., due to the implemented use case such as the use cases for architectural, cosmetic, food coloring, typeface, etc.), implemented applicator (e.g., brush, spray, hand), the target substrate (e.g., human skin, brick, ceramic, paper, etc.), type of printing method, implemented printer, and desired output (e.g., temporary, permanent, protective coating, waterproof, etc.). Dependent on the implementation, the composition may additionally include: cosolvents, co-binders and swelling agents, as well as paint, ink, or coating additives such as, but not limited to, fillers, wetting agents, surfactants, humectants, coalescents, crosslinkers, photoinitiators, photosensitizers, flow/leveling agents, slip agents, anti-blocking agents, finishing agents, plasticizers, rheology modifiers, adhesion promoters, defoamers, stabilizers, and any number of other additives.

As used herein, reference to a compound as a solvent or a cosolvent does not imply any restrictions on the compound and/or the concentration of the compound within the composition. Thus, unless explicitly stated otherwise, any reference to a compound as a solvent will imply that the compound may be either a majority concentration solvent (i.e., the solvent with the greatest concentration within the solution) or a minority concentration solvent (i.e., what is typically referred to as a cosolvent). As all examples include an aqueous based portion. Water may be referred to as a solvent, or cosolvent, in all embodiments.

As used herein, a substrate refers to any surface that the composition may be applied to. Dependent on implementation and paint composition, the applicable substrate may vary. Examples of potential substrates may include: packaging materials, sporting goods, automotive surfaces, credit cards, watch faces, footwear, paper, organic cloth, synthetic cloth, plastics, metals, walls, etc. In some variations, the substrate may not have a clear surface (e.g., porous materials). The term substrate may still be used for application of the composition to these “substrates” although no clear surface may be defined.

As used herein, painting (and all other forms of the verb) refers to applying the composition to a substrate (e.g., painting the substrate). For simplicity, the term painting may be used regardless of the method of application (e.g., applying cosmetic with a brush, finger painting, spray painting, printing, splashing, dyeing, etc.).

The term color is used for simplicity to discuss reflection of a certain wavelength, or bandwidth, of the electromagnetic spectrum. In this manner, unless explicitly stated otherwise “color”, and all terms associated with color (e.g., color solution, structural color, etc.) are in no way limited to a certain band of the electromagnetic spectrum (e.g., visible band). For example, color solution (also referred to as reflective solution) refers to a solution that when dries, leaves a photonic crystal arrangement that reflects a desired portion of the electromagnetic spectrum. Thus, as used herein, color, and all associated terms, may refer to reflection of any region(s) of the electromagnetic spectrum including visible light, ultraviolet light, and infrared light.

A reference to a composition color or design, refers to a solution, that when applied to a substrate and dried, forms a photonic crystal (a structural color), wherein the nano- or micro-structured material (e.g., through a self-assembly process) reflects the preferred applied color and/or design. For example, a reference to a green color composition (or green solution) refers to a composition, that when dried, forms a film with a photonic crystal structure that reflects sufficient green light; such that the appearance of the film is relatively green. Additionally, dependent on implementation, the “purity” or chroma of the green color may also be manipulated. That is, dependent on implementation, a green color solution may refer to a composition, that when dried, leaves behind photonic crystals that only reflects green light (i.e., a narrow wave band of light reflection around the range of wavelengths that are observed as green) or may refer to a composition that primarily reflects green light (i.e., a broad band of light is reflected with a peak reflection around green). In fact, the composition may enable any spectra for reflection, and thus any band (or multiple bands) of reflection may be incorporated, with some peak at green such that the film appears green.

To reiterate using wavelengths, the system enables construction of a reflective photonic crystal structure that may either reflect a very narrow band of wavelengths or a broad band of wavelengths, or any other band(s) of wavelengths. Thus, analogous to the composition color, as used herein, wavelength (or reflecting wavelength) will generally refer to a peak at approximately the stated wavelength, with no other limitation or implication on the range or profile of the reflected spectrum. Unless stated otherwise, the use of the term wavelength (or the term color) does not in any way limit this invention to a wavelength in the visible spectrum and/or to a narrow or broad band of wavelengths.

The measurement of color values may be done using the L*a*b* color space. The L*a*b* color space or the L*a*b* color model (i.e., the CIELAB color model) is known to a person skilled in the art. The L*a*b* color model is standardized e.g., in DIN EN ISO/CIE 11664-4:2020-03. Each perceivable color in the L*a*b*-color space is described by a specific color location within the coordinates {L*,a*,b*} in a three-dimensional coordinate system. The a*-axis describes the green or red portion of a color, with negative values representing green and positive values representing red. The b*-axis describes the blue and yellow portion of a color, with negative values for blue and positive values for yellow. Lower numbers thus indicate a more bluish color. The L*-axis is perpendicular to this plane and represents the lightness. The L*C*h color model is similar to the L*a*b* color model, but uses cylindrical coordinates instead of rectangular coordinates. In the L*C*h color model, L* also indicates lightness, C* represents chroma, and h is the hue angle. The value of chroma C* is the distance from the lightness axis (L*). The values are measured by making use of a Konica Minolta CM5 spectrophotometer. Analysis of the samples is done in accordance with the Konica Minolta CM5 standard operating procedure.

As a “coloring” property of the composition, the composition enables combinations of different color aqueous solutions to create different mixture colors. The composition may enable both additive coloring (e.g., RGB type coloring used in display/monitors) and subtractive coloring (e.g., CYMK coloring used in printer devices). As part of additive coloring, composition for different colors may be mixed, creating new color films that correspond to an averaging of wave lengths of the photonic crystal forming compositions. This mixing may occur prior to painting the composition onto a substrate, or may occur as part of a painting process wherein the color solutions mix during or after deposition on the substrate. As part of a hybrid additive/subtractive coloring, different photonic crystal color solutions may be layered, in conjunction with pigments or dyes, such that each color solution film layer reflects or absorbs a desired color spectra leaving behind the desired color.

Additionally, color mixing may be performed by depositing different color solutions on the substrate, curing or drying between the separate depositions. Through this method, considering a standard base of colors (e.g., RGB coloring), colors besides the base colors can be obtained through sequential deposition of either blue, green, or red constituent layers.

In some variations, the composition may be used for pointillistic “coloring”. That is, small dots of varying colors can be deposited such that individual dots are not distinguishable by the human eye without magnification.

The composition may include at least one block copolymer 110. The block copolymer 110 functions as the scaffold to form the ordered nano- or micro-structure from which colors arise. That is, block copolymers no may enable the solution to self-organize into the photonic crystals, i.e., structural colors. Each block copolymer 110 comprises molecules in arrangements (e.g., linear, brush, star) of blocks linked together through their reactive ends. Each block copolymers 110 is capable of forming different ordered phases at nano- to micro-scopic length scales. Each block copolymer 110 may correspond to a specific color and/or multiple colors. In variations where at least one block copolymer 110 comprises a plurality of block copolymers, multiple block copolymers together, may correspond to one color. The at least one brush block copolymer no, and the corresponding constituents of each, and all, the brush block copolymer may be prepared in the general manner as described in WO 2020/180427 and US 2021/0395463 A1. Additionally or alternatively, other methods may be incorporated for preparing the brush block copolymer.

Dependent on implementation, the at least one block copolymers 110 may comprise up to 80%, by weight, of the composition. In one implementation, the at least one block copolymers 110 comprise about 1-10% of the composition. In another implementation, the at least one block copolymers 110 comprise 10%-20% of the composition. In another implementation, the at least one block copolymers 110 comprise 20%-30% of the composition. In another implementation, the at least one block copolymers 110 comprise 30%-40% of the composition. In another implementation, the at least one block copolymers 110 comprise 40%-50% of the composition. In another implementation, the at least one block copolymers 110 comprise 50%-60% of the composition. In another implementation, the at least one block copolymers 110 comprise 60%-70% of the composition. In another implementation, the at least one block copolymers comprise 70%-80% of the composition. In another implementation, the at least one block copolymers 110 comprise 80%-90% of the composition.

The at least one block copolymers 110 may include any type of block copolymers as needed or required by implementation. Examples of block copolymer 110 types include: brush block copolymers, wedge-type block copolymers, hybrid wedge copolymers, linear block copolymers, or any other type of block copolymers. Dependent on implementation, all block polymers may be of a single type or of different types. For example, in one implementation the at least one block copolymer 110 may comprise two brush block copolymers. In another example, the at least one block copolymer 110 may comprise two brush block copolymers and a wedge-type block copolymer. In a third example, the at least one block copolymer 110 comprises a single block copolymer that includes both brush blocks and linear blocks.

In some variations, the at least one block copolymer no includes a brush block copolymer (also known as block polymers with a bottle brush polymer architecture, or graft copolymers). In some implementations, the brush block copolymer may have a tuned grafting density (e.g., by copolymerization of polymeric macromonomers and reactive diluents). Additionally or alternatively, the at least one block copolymer 110 may include multiple brush block copolymers. Brush block copolymers may provide shear thinning properties, i.e., lack of polymer chain entanglements of brush block copolymers may lead to a solution with reduced viscosity, as compared to a “typical” solution with polymers of similar size and/or similar molecular weight but with no brush architecture. Brush block copolymers with varied grafting densities may be prepared in the general manner as described within US 2021/0395463 A1, and the supporting information of T.-P. Lin et al., JACS 2017, 139 (10), p. 3896-3903, and the supporting information of T.-P. Lin et al., ACS Nano, 2017, 11 (11), p. 11632-11641.

In some brush block copolymer variations, block copolymers 110 may utilize highly tunable brush block copolymers. These brush block copolymers may have more than one polymer blocks, wherein at least one of which has one or more preselected properties. For example, for a graft copolymer with two polymer blocks (a first polymer block and a second polymer block) implementation, the first polymer block may have a preselected graft density, preselected graft distribution, and/or preselected degree of polymerization. The second polymer block may, or may not, have a preselected graft density, graft distribution, and/or degree of polymerization. The second polymer block (and potentially any additional polymer blocks of the graft copolymer for a more general implementation) may be the same or distinct as desired by implementation. In this manner the block copolymer may have highly tunable and deterministic nature, which may in turn contribute to the high tunability and versatility of the self-assembled structures, and associated methods, of the present invention.

In any embodiment of the brush block copolymers, the brush block copolymer may have a preselected graft density. The preselected graft density may be any value selected from the range of 0.01 to 1.00 (unitless ratio density). In other words, the diluent and macromonomer, and the amount (concentrations) of these building blocks may be preselected so as to result in a preselected graft density that is any value in the range of 0.01 to 1.00. That is, in any embodiment of the methods of synthesizing a graft copolymer disclosed herein, the graft density may be selected from the range of 0.01 to 1.00. For example, dependent on implementation, the said graft density may be selected from the range of 0.01 to 0.32, 0.32 to 0.34, 0.34 to 0.49, 0.49 to 0.51, 0.51 to 0.65, 0.65 to 0.68, 0.68 to 0.75, or 0.75 to 1.00.

In variations where the at least one block copolymer 110 comprises multiple brush block copolymers, a first brush block copolymer may have a preselected first graft density (also referred to above as the graft density). Additional brush block copolymers (e.g., a second brush block copolymer, a third brush block copolymer, and continuing up to an Nth brush block copolymer) may thus have corresponding preselected graft densities (e.g., a second graft density, a third graft density, and continuing up to an Nth graft density). As described previously, variations in the grafting density may also occur within each block copolymer, wherein distinct blocks of distinct block copolymers may have distinct properties (e.g., distinct graft densities). The general form for a plurality of brush block copolymers, wherein each brush block copolymer potentially has a distinct number of graft densities is: a first graft density for a first brush block copolymer, a second graft density for the first brush block copolymer, . . . , an Nth brush block density for the first brush block polymer, a first graft density for a second brush block copolymer, the second graft density for the second brush block copolymer, . . . , an N′th (n prime) graft density for the second brush block copolymer, . . . a first graft density for an Nth brush bock copolymer, a second graft density for the Nth brush block copolymer, . . . , and an N″th (n double prime) graft density for the Nth brush block copolymer.

In any embodiment of the system of the brush block copolymers disclosed herein, any said graft density (i.e., the first graft density through an Nth graft density), may be selected from the range of 0.01 to 1.00. In any embodiment of the methods of synthesizing a graft copolymer disclosed herein, any said graft density (i.e., the first graft density through an Nth graft density), may be selected from the range of 0.01 to 1.00. In any embodiment of the methods of synthesizing a graft copolymer disclosed herein, any said graft density (i.e., the first graft density through an Nth graft density), may be selected from the range of 0.01 to 0.32, 0.32 to 0.34, 0.34 to 0.49, 0.49 to 0.51, 0.51 to 0.65, 0.65 to 0.68, 0.68 to 0.75, or 0.75 to 1.00.

The polymer molecular weights: number average molecular weight (Mₙ) and weight average molecular weight (M_{W}); and a molecular weight distributions: PDI: polydispersity index) may be determined via gel permeation chromatography (GPC) using a combination of differential refractive index (dRI) and two light scattering (LS) detectors. The use of LS detectors enables analysis of the absolute molecular weight for polymer samples. The solvent used for all samples was tetrahydrofuran (THF), with the elution rate of 1.0 mL/minute. Polymer samples were fully dissolved in HPLC grade THF at concentrations ranging from 2.5-7.5 mg/mL, passed through 0.5 um syringe filters, and injected via autosampler. The porous column stationary phase consisted of two Malvern T600 single pore columns with exclusion limits of 20,000,000 Da for poly(styrene). Molecular weights and PDIs were determined via OMNISEC software.

Generally, a sample of brush block copolymer may contain a distribution of molecular weights, as quantified by the PDI. Modification of the PDI may function to increase or decrease the intensity, and/or lambda max of the reflected wavelength(s) (the wavelength of the strongest reflection) of the deposited coating containing brush block copolymer. In many variations, the uniformity of brush block copolymers may be controlled by the production conditions. In one variation of the brush block copolymers, a polydispersity index of the graft copolymer may be selected from the range of 1.00 to 1.30. In another variation, the polydispersity index of the graft copolymer may be selected from the range of 1.00 to 1.20. In another variation, the polydispersity index of the graft copolymer may be selected from the range of 1.00 to 1.10.

In some variations, each block copolymer from the at least one the block copolymer 110, may include a molecular structure(s) that organizes into photonic crystals. Depending on implementation, the block copolymer 110 may provide the scaffolding for a structure such that once dried, will form the desired color composition (i.e., form photonic crystals that reflect the desired wavelength(s) of light). In one variation, each block copolymer 110 comprises a single block molecular structure, wherein the single block solution forms a photonic crystal with specific reflected wavelength. Alternatively, each block copolymer 110 may have multiple blocks, wherein the multiple block solution forms a photonic crystal with specific reflected wavelengths corresponding to each block.

In certain variations, the composition exhibits a photonic band gap (wavelength of maximum reflection) at a wavelength in a range from about 200 nm to about 2000 nm. In one example, the composition may exhibit a photonic band gap at a wavelength in a range from about 200 nm to 400 nm, from 400 nm to 750 nm, from 750 nm to 1600 nm from 1600 nm to 2000 nm, or any combination of two or more of these ranges.

In some variations, the at least one block copolymer 110 comprises two or more block copolymers. For example, the at least one block copolymer 110 comprises a mixture of two block copolymers, a first block copolymer and a second block copolymer, wherein the block copolymer mixture solution forms a specific color photonic crystal through the mixture solution. Through the use of two or more block copolymers 110, a spectrum of colors may be created by varying the relative concentration of the first block copolymer to the concentration of the second block copolymer. That is, a color solution comprising of just the first block copolymer 110 may provide a first color; and a color solution comprising of just the second block copolymer may provide a second color. A combined color solution comprising varying ratios of the first block copolymer 110 and the second block copolymer, may have any color from the spectrum of colors between the first color and the second color dependent on the ratio of the number of first block copolymers to the number of second block copolymers.

In some variations, the at least one block copolymer 110 may comprise three, or more, block copolymers. In the same manner as two block copolymers, the relative ratio of each block copolymer may determine the color and other properties of the final color solution. A mixture of a plurality of block copolymers 110 may be used to generate any range of colors, with varying reflectivity, chromaticity, opacity, and brightness.

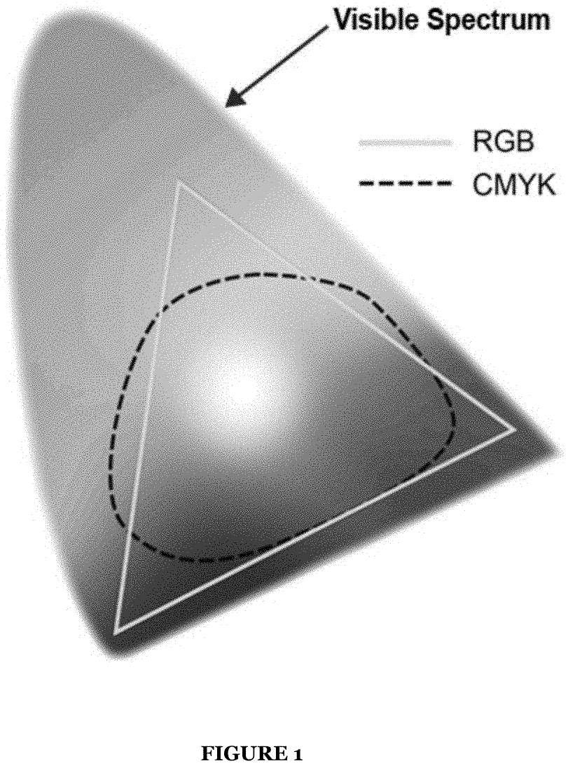

In one variation, the system may comprise multiple photonic crystal forming color solutions, wherein each color solution includes at least one block copolymer 110. In this variation, each color solution (based on its corresponding block copolymer mixture) may correspond to a specific color. Different colors may then be generated by mixing or overlaying (e.g., by printing different concentrations of different ink solutions on top of each other) by through additive coloring. For example, the system may comprise a first color solution corresponding to a first color (e.g., red), a second color solution corresponding to a second color (e.g., green), and a third color solution corresponding to a third color (e.g., blue). By layering different concentrations of the three-color solutions, colors in the RGB gamut may be obtained, as shown in FIG. 1. This method implementation of the composition may be generalized to obtain any general additive coloring gamut.

The color solution may include at least one solvent 120. The solvent functions to help maintain the solubility of other color solution components. The at least one solvent 120 may include water, thereby making the color solution an aqueous solution. In many variations, the at least one solvent 120 may further include an organic solvent. Generally, the composition may include multiple solvents 120, i.e., cosolvents, wherein the solvents/cosolvents may provide additionally desired properties to the color solution. Dependent on the implementation, a wide variety of solvents may be used to provide the desired properties necessary for the implementation. For example: the solvent 120 may enable the modification of the coating properties of the solution, provide a scope of slower or faster drying compatible with printers, optimize printing/jetting with inkjets, help modify the color solution viscosity (e.g., to prevent runny make up), decrease biological toxicity of the color solution, and/or modify the color solution drying rates.

Dependent on the implementation, the solvent 120 may itself be a reactive component. That is, in some variations, the solvent 120 may comprise a reactive component such as: an acrylate or methacrylate monomer or oligomer, or epoxy monomer or oligomer, or any combination therein. In one variation, the solvent 120 includes a reactive monomer or oligomer. Alternatively, the solvent 120 may comprise other reactive components. A reactive component solvent 120 may be necessary for the use of UV curable ink compositions. Solvents 120 may any suitable conventional organic solvents to those skilled in the art and can be used as organic solvents or co-solvents in the color solution formulations. The term “organic solvent” is known to those skilled in the art, in particular from Council Directive 1999/13/EC of 11 Mar. 1999. Examples of such organic solvents would include heterocyclic, aliphatic, or aromatic hydrocarbons, or their partially fluorinated variants, such as, for example, 4-chlorobenzotrifluoride, mono- or polyhydric alcohols, especially methanol and/or ethanol, 1-methoxy-2-propanol, 1-propoxy-2-propanol, benzyl alcohol, butyl lactate, ethers, esters, such as, for example, ethyl acetate, propyl acetate, butyl acetate, pentyl acetate, ketones, such as, for example, acetone, cyclohexanone, methyl ethyl ketone, methyl isobutyl ketone, isophorone, and amides, such as, for example, N-methylpyrrolidone, N-ethylpyrrolidone, dimethylformamide, toluene, xylene, butanol, ethyl glycol and butyl glycol and also their acetates, ethyl glycol and butyl glycol and also their ether acetates, butyl diglycol, diethylene glycol dimethyl ether, or mixtures thereof.

The at least one solvent 120 preferably includes water. Water may function as a hydrophilic solvent. Additionally, water may function as a solvent that is less toxic for biological use. Generally, the composition comprises at least 10% water, by weight; although the composition may be constructed with less water, if desired. Dependent on the desired implementation, water may comprise up to 80%, by weight, of the color solution. Generally, the concentration of water in the color solution may be controlled and is implementation specific. In one example, water comprises approximately 0%-10% of the color solution. In another example, water comprises approximately 10%-20% of the color solution. In a third example, water comprises approximately 20%-30% of the color solution. In another example, water comprises approximately 30%-40% of the color solution. In another example, water comprises approximately 40%-50% of the color solution. In another example, water comprises approximately 50%-60% of the color solution. In another example, water comprises approximately 60%-70% of the color solution. In another example, water comprises approximately 70%-80% of the color solution.

In some variations, water may comprise a changing concentration of the color solution. That is, water may comprise an initial concentration of the color solution, wherein the water concentration may decrease over time. This may occur with application of the color solution onto a substrate, wherein the water is removed (e.g., through evaporation) as the color solution “dries” on the substrate, leaving behind a desired photonic crystal arrangement.

In some variations, the at least one solvent 120 may further comprise an amphipathic solvent (e.g., acetone). The amphipathic solvent may improve mixing and dissolution, or dispersion, or stabilization of dispersion, of system compounds with the water solvent. That is, the amphipathic solvent(s) may help better solubilize block-copolymers or other formulation components, or stabilize dispersions of block copolymers or other formulation components in the color solution. The amphipathic solvent may comprise a water-miscible, or partially water-miscible, organic solvent. Examples of amphipathic solvents include: acetone, tetrahydrofuran, 1-methoxy-2-propanol, benzyl alcohol, and ethanol.

The amphipathic solvent may comprise a single solvent or multiple amphipathic solvents. As the amphipathic solvent may have many additional properties beyond generally increasing miscibility, any number of amphipathic solvents may be included in the color solution. In one variation, the solvent includes a single amphipathic solvent. In another variation, the solvent includes two amphipathic solvents. In another variation, the solvent includes three amphipathic solvents. In another variation, the solvent includes four amphipathic solvents. In another variation, the solvent includes five amphipathic solvents. In another variation, the solvent includes six amphipathic solvents. In another variation, the solvent includes seven amphipathic solvents. In another variation, the solvent includes eight amphipathic solvents. In another variation, the solvent includes nine amphipathic solvents. In another variation, the solvent includes ten amphipathic solvents.

Dependent on implementation, the amphipathic solvent may comprise varying concentrations of the solvent (or composition). Generally, the amphipathic solvent may comprise between approximately 1% to approximately 60% of the composition. In one example the amphipathic solvent comprises approximately 5% to approximately 40% of the composition. In another example, the amphipathic solvent comprises approximately 10% to approximately 30% of the composition.

In some variations, the system may include at least one swelling agent. The at least one swelling agent may comprise up to 70% of the composition. The at least one swelling agent may function to modulate the color solution viscosity (e.g., modulate the viscosity by 2-4 orders of magnitude) and/or alter the color of the coatings. In some variations, the swelling agent may comprise a linear polymer. Examples of linear polymer swelling agents may include: optionally substituted aliphatic polyesters, poly(amino acids), copoly(ether-esters), polyalkylenes oxalates, poly-amides, poly(iminocarbonates), polyorthoesters, polyoxaesters, polyamidoesters, polyoxaesters containing amine groups, poly(anhydrides), polyphosphazenes, polysiloxanes, polyethylene, polyethylene terephthalate, poly(tetrafluoro-ethylene), polycarbonate, polypropylene, poly lactic acid (PLA), polyglycolic acid (PGA), polycaprolactone (PCL), poly(Lactide-co-Glycolide) (PLGA), polydioxanone (PDO), trimethylene carbonate (TMC), polyethyleneglycol (PEG), polyurethanes, polyacrylonitriles, polyanilines, polyvinyl carbazoles, polyvinyl chlorides, polyvinyl fluorides, polyvi-nyl imidazoles, polyvinyl alcohols, polystyrenes and poly (vinyl phenols), aliphatic polyesters, polyacrylates, polymethacrylates, polystyrenes, chlorosulphonated poly-olefins, and copolymers thereof. Additionally or alternatively, block or nonlinear polymer architectures of the above may be used as swelling agents (e.g. star, dendritic, cyclic). In some variations, the swelling agent may include the above polymers with modifications enabling self-crosslinking or crosslinking with other molecules or compounds.

In some variations, the system may include at least one co-binder component (also referred to as a filler). The co-binder may provide a multitude of functions. The function of the co-binder may include lowering the solution viscosity, raising the solution viscosity, improving the mechanical properties of the ink solution as a coating, improving the coating durability, lowering the glass transition temperature of the coating, raising the glass transition temperature of the coating, improving coating performance in the presence of temperature cycling, providing water resistance of the coating, providing humidity resistance of the coating, improving the ink solution wetting on substrates, improving the coating adherence on the substrate, improving the optical properties of the coating through improved chroma, improving the optical properties of the coating through reduced haze. Generally speaking, the co-binder may include any non-volatile material that is not a brush block copolymer or swell polymer. For biological use cases, the co-binder may also need to be non-toxic. The co-binder may be reactive or unreactive. In variations where a reactive co-binder is implemented, the co-binder may provide crosslinking, adhesion, or other “binding” properties. Dependent on implementation, the co-binder may comprise a minority or majority proportion of the composition. The co-binder may include polymer resins comprised of polystyrenics, polyesters, polyolefins, polyvinyl ethers, polyethers, polyacrylates, polymethacrylates, polyacrylamides, polymethacrylamides, polyurethanes, polysiloxanes, polyamides, polyethylene terephthalates, polybutylene terephthalates, polyvinyl chlorides, melamine resins, phenolic resins, urea resins, alkyd resins, epoxy resins, polyetherketones, polyphenylene sulfides, polyvinyl alcohols, and/or their copolymers, and/or their acrylate/methacrylate functionalized variants, and/or their epoxy functionalized variants. The co-binder may include cellulose ester resins or sucrose ester compounds. The co-binder 140 may comprise up to 70% of the solution. In some variations, the co-binder may include cellulose acetate butyrate resins. In some variations, the co-binder comprises sucrose acetate iso-butyrate (SAIB-100). In some variations the co-binder comprises polyvinyl alcohol. In one example, the co-binder comprises SAIB-100 with polyvinyl alcohol. In some variations, the co-binder comprises sucrose benzoate.

In some variations, the color solution may include one or more stabilizers. Stabilizers function to improve the stability of the color solution, i.e., improve the solution lifespan and/or solution solubility. Stabilizers may also function to improve the stability of the coating. Examples of stabilizer types include: UV absorbers (e.g. benzotriazoles), hindered amine light stabilizers (HALS), antioxidants, and thiosynergists.

In some variations, the color solution may comprise amphipathic/surfactant compounds. These surfactant compounds may improve the solution application (e.g., improve wetting of a substrate surface). Examples of surfactants may include anionic surfactants: carboxylates, phosphates, sulfates, and sulfonates. Examples of cationic surfactants: alkylamine salts, quaternary alkylammonium salts, aromatic quaternary ammonium salts, heterocyclic quaternary ammonium salts. Examples of surfactants can include fluoro surfactants and Zwitterionic surfactants. Examples of foaming agent surfactants include: Defoamer EDW-S, Defoamer EDW, Defoamer EDW-707, Defoamer 31, and Defoamer EDW-709. Examples of nonionic surfactants: ester ether type, ester type, ether type. Some specific examples include: polysiloxane based, acrylate functional polysiloxane, polyacrylate copolymer, common emulsifiers (e.g., lecithin, mustard, sodium phosphates, mono- and diglycerides, sodium stearoyl lactylate, DATEM, and amphipathic proteins), sodium stearate, sulfobetaine, LD50, quaternary ammonium compounds, dialkyldimethylammonium chlorides (DDAC, DSDMAC), dioctyl sodium sulfosuccinate (DOSS), sorbitan monooleate (Span 80), polyoxyethylenated sorbitan monooleate (Tween-80), linear alkylbenzene sulfonates (LAS) and alkyl phenol ethoxylates (APE).

In some variations, crosslinking functional groups may be incorporated. Depending on variation, crosslinking functional groups may be incorporated with the co-binder and/or swelling agent. In some variations, suitable crosslinking functional groups may contain one or more olefinic double bonds. They can be of high molecular weight (oligomeric) or low molecular weight (monomeric). Examples of monomers with a double bond are alkyl or hydroxyalkyl acrylates or methacrylates, for example methyl acrylate, ethyl acrylate, butyl acrylate, 2-ethylhexyl acrylate or 2-hydroxyethyl acrylate, isobornyl acrylate, tetrahydrofurfuryl acrylate, methyl methacrylate, or ethyl methacrylate. Examples of monomers having two or more double bonds are ethylene glycol diacrylate, propylene glycol diacrylate, neopentyl glycol diacrylate, hexamethylene glycol diacrylate, or bisphenol A diacrylate, trimethylolpropane triacrylate, pentaerythiritol triacrylate or tetraacrylate, divinylbenzene, divinyl succinate, diallyl phthalate, triallyl phosphate, triallyl isocyanurate or tris(2-acryloylethyl)isocyanurate. Examples of higher molecular weight (oligomeric) polyunsaturated compounds are acrylicized epoxy resins, polyurethanes, polyethers and polyesters which are acrylized or contain vinyl ether or epoxy groups. Further examples of unsaturated oligomers are unsaturated polyester resins which are mostly prepared from maleic acid, phthalic acid and one or more diols and have molecular weights of from about 500 Da to 3,000 Da. In some variations, suitable crosslinking functional groups may contain one or more epoxy units. Said component is preferably a cycloaliphatic epoxy compound, and/or it may be a glycidyl ether compound. The cycloaliphatic epoxy compound can be a cycloalkane oxide-containing compound obtained by epoxidizing a cycloalkane-containing compound with an oxidizing agent. The cycloalkane of the cycloalkane oxide-containing compound can be a cyclohexene or cyclopentene. The glycidyl ether compound can be a di- or polyglycidy; ether obtained by reacting an aliphatic polyhydridic alcohol or an alkylene oxide adduct thereof, and epichlorohydrin. Examples of the polyhydridic alcohols include alkylene glycols, such as ethylene glycol, propylene glycol, and 1,6-hexanediol. In some variations, suitable crosslinking functional groups may contain an oxetane or polyol. In some variations, suitable crosslinking functional group may contain one or more vinyl ether compounds. Examples include di- or tri-vinyl ether compounds, such as ethylene glycol divinyl ether. Diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether.

The color solution may contain one or more photoinitiators. Phosphine oxides are well known photoinitiators for the photopolymerization of ethylenically unsaturated compounds. Examples of commercially available products of the phosphine oxide compounds include IRGACURE 819 (BASF SE) and DAROCUR TPO (BASF SE). Alpha-hydroxy ketone compounds are also potential photoinitiators. Examples of commercially available products of the alpha-hydroxy ketone compounds include ESACURE KIP 150 (from DKSH Management, ltd), IRGACURE 127 (BASF SE), IRGACURE 2959 (BASF SE), and IRGACURE 184 (BASF SE).

The color solution may also include a photosensitizer. Such a photosensitizer is suitably arranged to absorb radiation from a light source and facilitate transfer of energy to a photoinitiator. Photosensitizers may include an anthracene, pyrene, carbazole, thiazine, phenothiazine or thioxanthene moiety.

In some variations, the composition may further comprise a substrate, wherein the aqueous photonic crystal forming solution is applied to the substrate. That is, the composition may comprise an aqueous photonic crystal ink solution, comprising: at least one block polymer; at least one solvent that includes water; at least one co-binder; and a substrate; wherein the aqueous photonic crystal ink solution forms a structural color film on the substrate. Dependent on implementation, as described above, the aqueous photonic crystal ink solution may include additional cosolvents, swelling agents, as well as paint, ink, and coating additives. The substrate may comprise any appropriate surface, or porous material, that through application of the aqueous photonic crystal ink solution, enables formation of the colored film surface on, or through (for porous materials), the substrate. Dependent on implementation, the substrate may comprise organic or inorganic materials. Examples of substrates include: skin, organic tissue, organic fabric, synthetic fabric, wood, metal, cement, plastic, stone, plaster, walls, and membranes.

In some variations, the system may additionally include an application system, comprising components necessary to create, mix, maintain, and apply the color solution, and post-processing. The application system may provide important functionality for premixing desired color arrangements and/or for appropriately applying layers of color solution to achieve a desired color and design. Examples of mixing components may include a latex mixer and/or a high shear mixer. Examples of post-processing components may include a drying lamp (e.g., an infrared drying lamp).

As part of the mixing system, how and when the composition components are combined may have significant effects on the color solution properties. Components of the composition may be divided into three categories, hydrophilic components, hydrophobic components, and amphipathic components. In one variation, hydrophilic components are initially mixed in water, amphipathic components are mixed with the hydrophobic components and then added to the hydrophilic components. In another variation, the hydrophilic components are initially mixed in water, then mixed with the amphipathic components, and then the hydrophobic components are added. In another variation, the hydrophobic components are initially mixed, the hydrophilic components are mixed with water and then with the amphipathic components; once the hydrophilic components and the amphipathic components are mixed, they are then added to the hydrophobic components. In another variation, the hydrophobic components are initially mixed, the amphipathic components are added, and then the hydrophilic components are then added.

In some variations, the composition may comprise a precursor state (i.e., non-functioning state). In these variations, the composition may comprise an inactive state, such that with the addition of solvent (e.g., water), the composition becomes “active” and functions as described above. Dependent on implementation, ordered mixing steps may be required to add the solvent (e.g., addition of water and then the addition of an organic solvent). The precursor state may be a “dry” state (e.g., only non-fluids), or a “concentrate” state (e.g., a paint composition solution that needs to be initially mixed down to be used.

In one example the precursor state comprises a “dry” composition, wherein the dry precursor state comprises at least one block copolymer, at least one co-binder (e.g., sucrose acetate iso-butyrate or sucrose benozoate), and at least one surfactant (e.g., DDAC). The composition may be stored, transported, etc., in this state. Once composition is ready to be used the at least one solvent (e.g., water) may then be mixed with dry composition to enable the composition to function as a paint. Dependent on implementation (e.g., desired color, hue, brightness, etc.), the order of mixing in the solvent(s) may vary. In one implementation, the dry state composition is brought to an active state by dissolving the dry state compounds, in an organic, or amphipathic, solvent, and then adding water to the mixture.

In another example, the precursor state comprises a “concentrate composition, wherein the concentrate concentration comprises at least one block copolymer, at least one co-binder, at least one surfactant. The precursor concentrate solution may then be brought to an active state by the addition of diluting solvents.

As described above, the composition may have many variations of color solutions. Herein, multiple example aqueous color solution compositions are presented. In addition to the color solution components mentioned above, for successful application, certain rheological conditions may also be required. For example, for ink-jet printing the color solution may require a viscosity that is preferably uniform or decreases as the frequency of oscillation increases. Dependent on the color solution implementation, other conditions may be needed. Examples of potentially necessary conditions include: color solution drying time, temperature tolerance, vapor pressure, density, surface tension, and biological toxicity.

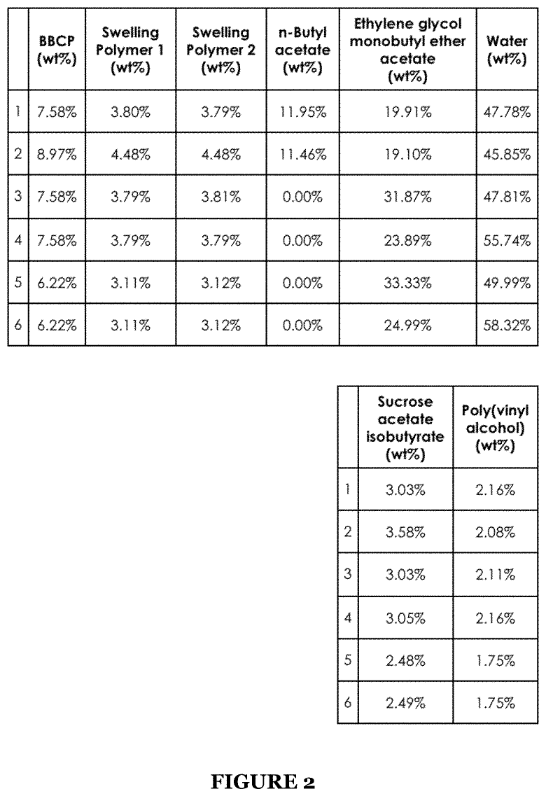

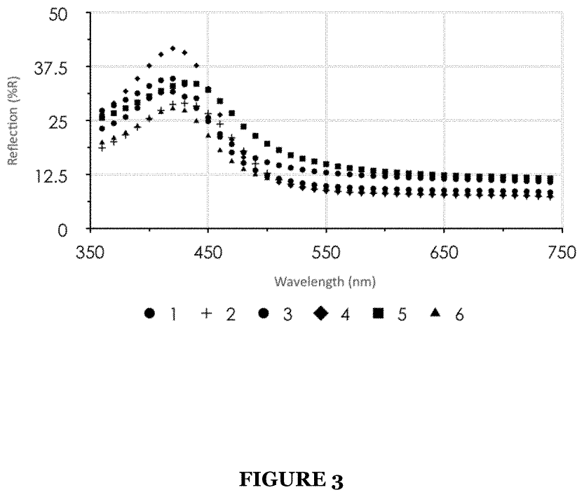

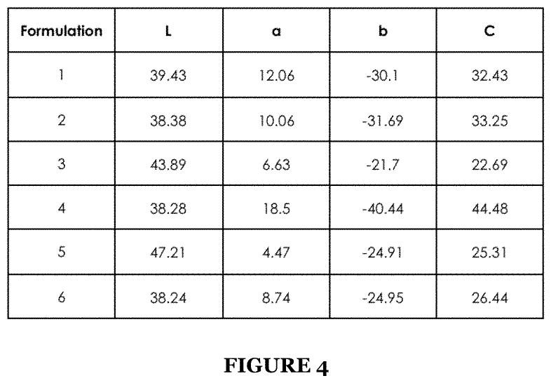

In a first variation for a color solution with a high-water content, as shown in FIGS. 2-4, the solution comprises at least one brush block copolymer, at least one swelling agent, at least one co-binder, and at least one solvent, wherein the at least one solvent includes water. The at least one swelling agent comprises polylactic acid (PLA) and polystyrene (PS); the at least one co-binder comprises sucrose acetate isobutyrate (referred to as SAIB-100 or SAIB) and polyvinyl alcohol; and the at least one solvent comprises: a majority water, and two additional solvents. In these variations, the solvents include n-butyl acetate and ethylene glycol monobutyl ether acetate. The at least one block copolymer may be any block copolymer and/or combination of block copolymers (e.g., a combination of block copolymers that paint to a desired color), wherein in these examples the implemented desired color is violet, as shown in FIG. 3; and the precise color (i.e., L*a*b color in addition to C for Chroma) of each formulation is shown in FIG. 4.

In a first example of the first variation (formulation 1) for a violet color solution, as shown in FIG. 2, the at least one block copolymer concentration is approximately 5%-10-%, the PLA concentration is approximately 0.01%-5.00%, the PS concentration is approximately 0.01%-5.00%, the SAIB concentration is approximately 0.01%-5.00%, the polyvinyl alcohol is approximately 0.01%-5.00%, the n-butyl acetate concentration is approximately 10%-15%, the ethylene glycol monobutyl ether acetate concentration is approximately 17.5%-22.5%, and the H₂O concentration is approximately 45%-50%. of the solution. As shown in FIG. 3, this implementation color solution is a precursor to an applied violet color.

In a second example of the first variation (formulation 2) for a violet color solution, as shown in FIG. 2, the at least one block copolymer concentration is approximately 5%-10-%, the PLA concentration is approximately 2.5%-7.5%, the PS concentration is approximately 2.5%-7.5%, the SAIB concentration is approximately 0.01%-5.00%, the polyvinyl alcohol is approximately 0.01%-5.00%, the n-butyl acetate concentration is approximately 10%-15%, the ethylene glycol monobutyl ether acetate concentration is approximately 17.5%-22.5%, and the H₂O concentration is approximately 42.5%-52.5%. of the solution. As shown in FIG. 3, this implementation color solution is a precursor to an applied violet color.

In a third example of the first variation (formulation 3) for a violet color solution, as shown in FIG. 2, the at least one block copolymer concentration is approximately 5%-10%, the PLA concentration is approximately 0.01%-5.00%, the PS concentration is approximately 0.01%-5.00%, the SAIB concentration is approximately 0.01%-5.00%, the polyvinyl alcohol is approximately 0.01%-5.00%, the n-butyl acetate concentration is approximately 0.00%, the ethylene glycol monobutyl ether acetate concentration is approximately 30%-35%, and the H₂O concentration is approximately 45%-50%. of the solution. As shown in FIG. 3, this implementation color solution is a precursor to an applied violet color.

In a fourth example of the first variation (formulation 4) for a violet color solution, as shown in FIG. 2, the at least one block copolymer concentration is approximately 5%-10%, the PLA concentration is approximately 0.01%-5.00%, the PS concentration is approximately 0.01%-5.00%, the SAIB concentration is approximately 0.01%-5.00%, the polyvinyl alcohol is approximately 0.01%-5.00%, the n-butyl acetate concentration is approximately 0.00%, the ethylene glycol monobutyl ether acetate concentration is approximately 22.5%-27.5%, and the H₂O concentration is approximately 52.5%-57.5%. of the solution. As shown in FIG. 3, this implementation color solution is a precursor to an applied violet color.

In a fifth example of the first variation (formulation 5) for a violet color solution, as shown in FIG. 2, the at least one block copolymer concentration is approximately 5%-10%, the PLA concentration is approximately 0.01%-5.00%, the PS concentration is approximately 0.01%-5.00%, the SAIB concentration is approximately 0.01%-5.00%, the polyvinyl alcohol is approximately 0.01%-5.00%, the n-butyl acetate concentration is approximately 0.00%, the ethylene glycol monobutyl ether acetate concentration is approximately 30%-35%, and the H₂O concentration is approximately 47.5%-52.5%. of the solution. As shown in FIG. 3, this implementation color solution is a precursor to an applied violet color.

In a sixth example of the first variation (formulation 6) for a violet color solution, as shown in FIG. 2, the at least one block copolymer concentration is approximately 5%-10%, the PLA concentration is approximately 0.01%-5.00%, the PS concentration is approximately 0.01%-5.00%, the SAIB concentration is approximately 0.01%-5.00%, the polyvinyl alcohol is approximately 0.01%-5.00%, the n-butyl acetate concentration is approximately 0.00%, the ethylene glycol monobutyl ether acetate concentration is approximately 22.5%-27.5%, and the H₂O concentration is approximately 55%-60%. of the solution. As shown in FIG. 3, this implementation color solution is a precursor to an applied violet color.

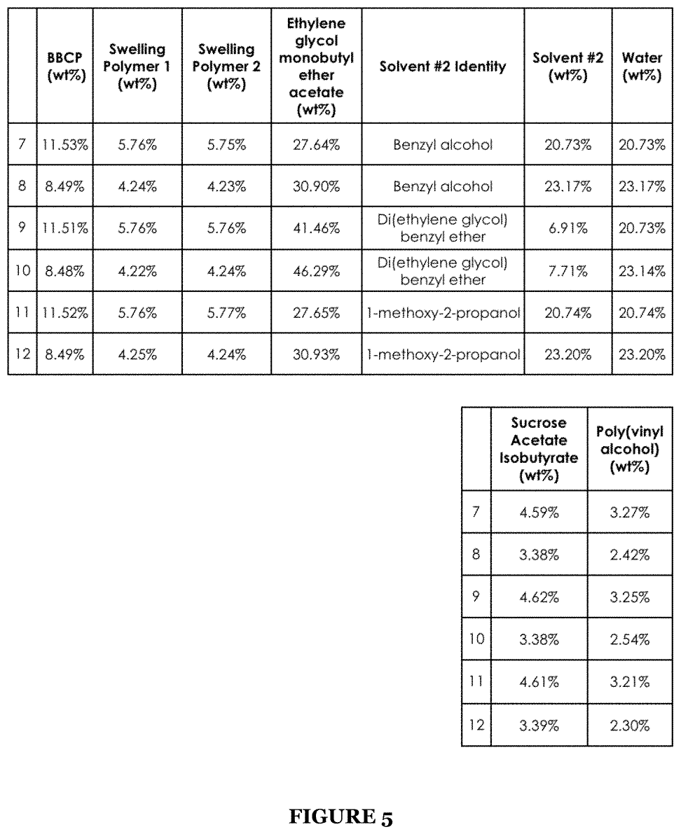

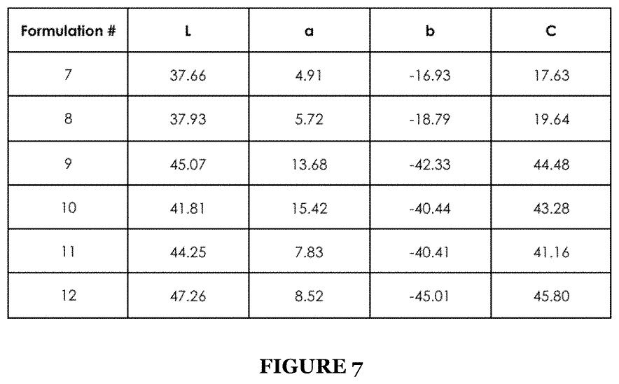

In a second variation for a color solution that further includes an amphipathic solvent, as shown in FIGS. 5-7, the solution comprises at least one block copolymer, at least one swelling agent, at least one co-binder, and at least one solvent, wherein the at least one solvent includes water. The at least one swelling agent comprises polylactic acid (PLA) and polystyrene (PS), the at least one co-binder comprises SAIB-100 (referred to as SAIB), and the at least one solvent comprises: an organic solvent, an amphipathic solvent, and water. In these variations, the organic solvent is ethylene glycol monobutyl ether acetate and the amphipathic solvent is changes per example. The at least one block copolymer may be any block copolymer and/or combination of block copolymers (e.g., a combination of block copolymers that print to a desired color), wherein in these examples the implemented desired color ranges from ultraviolet to blue.

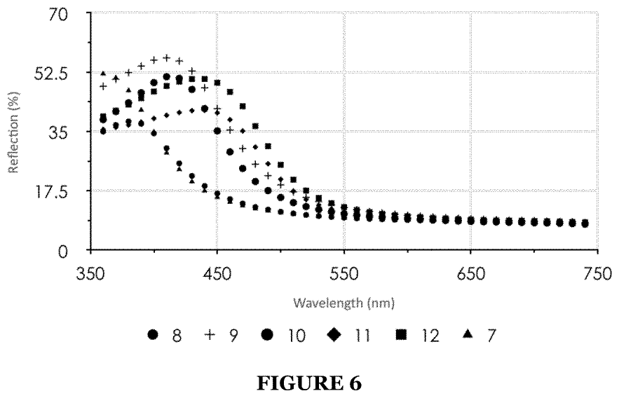

In one example of the second variation (formulation 7) for a violet-ultraviolet color solution, as shown in FIG. 5, the at least one block copolymer concentration is approximately 10%-15%, the PLA concentration is approximately 2.5%-7.5%, the PS concentration is approximately 2.5%-7.5%, the SAIB concentration is approximately 2.5%-7.5%, the polyvinyl alcohol concentration is approximately 2.5%-7.5%, the ethylene glycol monobutyl ether acetate concentration is approximately 25%-30%, the amphipathic solvent is benzyl alcohol with a concentration approximately 17.5%-22.5% and the H₂O concentration is approximately 17.%-22.5%. As shown in FIG. 6, this implementation color solution is a precursor to an applied violet-ultraviolet color.

In a second example of the second variation (formulation 8) for a violet-color solution, as shown in FIG. 5, the at least one block copolymer concentration is approximately 5%-10%, the PLA concentration is approximately 2.5%-7.5%, the PS concentration is approximately 2.5%-7.5%, the SAIB concentration is approximately 2.5%-7.5%, the polyvinyl alcohol concentration is approximately 0.01%-5.00%, the ethylene glycol monobutyl ether acetate concentration is approximately 27.5%-32.5%, the amphipathic solvent is benzyl alcohol with a concentration approximately 20%-25% and the H₂O concentration is approximately 20%-25%. As shown in FIG. 6, this implementation color solution is a precursor to an applied violet color.

In a third example of the second variation (formulation 9) for a violet-color solution, as shown in FIG. 5, the at least one block copolymer concentration is approximately 10%-15%, the PLA concentration is approximately 2.5%-7.5%, the PS concentration is approximately 2.5%-7.5%, the SAIB concentration is approximately 2.5%-7.5%, the polyvinyl alcohol concentration is approximately 0.01%-5.00%, the ethylene glycol monobutyl ether acetate concentration is approximately 40%-45%, the amphipathic solvent is di(ethylene glycol) benzyl ether with a concentration approximately 5%-10% and the H₂O concentration is approximately 17.5%-22.5%. As shown in FIG. 6, this implementation color solution is a precursor to an applied violet color.

In a fourth example of the second variation (formulation 10) for a violet-color solution, as shown in FIG. 5, the at least one block copolymer concentration is approximately 5%-10%, the PLA concentration is approximately 2.5%-7.5%, the PS concentration is approximately 2.5%-7.5%, the SAIB concentration is approximately 0.01%-5.00%, the polyvinyl alcohol concentration is approximately 0.01%-5.00%, the ethylene glycol monobutyl ether acetate concentration is approximately 42.5%-47.5%, the amphipathic solvent is di(ethylene glycol) benzyl ether with a concentration approximately 5%-10% and the H₂O concentration is approximately 20%-25%. As shown in FIG. 6, this implementation color solution is a precursor to an applied violet color.

In a fifth example of the second variation (formulation 11) for a blue-color solution, as shown in FIG. 5, the at least one block copolymer concentration is approximately 10%-15%, the PLA concentration is approximately 2.5%-7.5%, the PS concentration is approximately 2.5%-7.5%, the SAIB concentration is approximately 2.5%-7.5%, the polyvinyl alcohol concentration is approximately 0.01%-5.00%, the ethylene glycol monobutyl ether acetate concentration is approximately 25%-30%, the amphipathic solvent is 1-methoxy-2-propanol with a concentration approximately 17.5%-22.5% and the H₂O concentration is approximately 17.5%-22.5%. As shown in FIG. 6, this implementation color solution is a precursor to an applied blue color.

In a sixth example of the second variation (formulation 12) for a blue-color solution, as shown in FIG. 5, the at least one block copolymer concentration is approximately 5%-10%, the PLA concentration is approximately 2.5%-7.5%, the PS concentration is approximately 2.5%-7.5%, the SAIB concentration is approximately 0.01%-5.00%, the polyvinyl alcohol concentration is approximately 0.01%-5.00%, the ethylene glycol monobutyl ether acetate concentration is approximately 27.5%-32.5%, the amphipathic solvent is 1-methoxy-2-propanol with a concentration approximately 20%-25% and the H₂O concentration is approximately 20%-25%. As shown in FIG. 6, this implementation color solution is a precursor to an applied blue color.

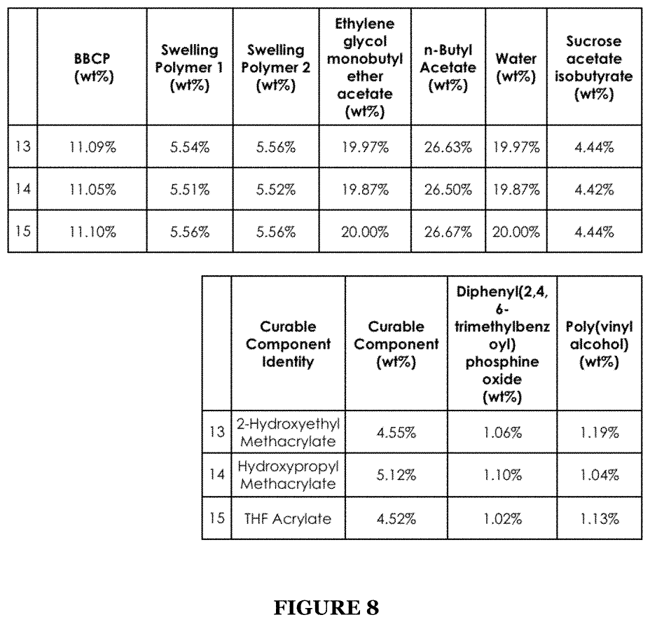

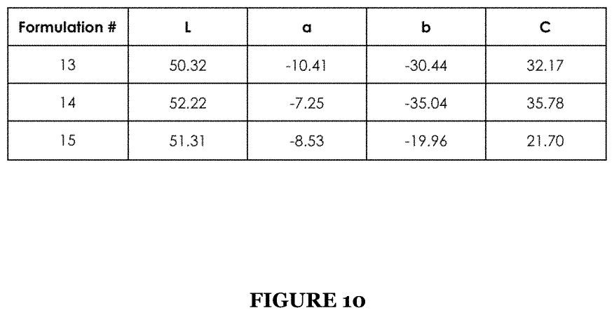

In a third variation for a color solution that includes curable monomer additives, as shown in FIGS. 8-10, the solution comprises at least one block copolymer, at least one swelling agent, at least one co-binder, and at least one solvent, wherein the at least one solvent includes water, at least one photo-initiator, and at least one curable additive. The at least one swelling agent comprises polylactic acid (PLA) and polystyrene (PS), the at least one co-binder comprises SAIB-100 and polyvinyl alcohol, the at least one solvent comprises an organic solvent and water, the curable additive varies per example, and the photoinitiator comprises diphenyl(2,4,6-trimethylbenzoyl) phosphine oxide. In these variations, the organic solvent is ethylene glycol monobutyl ether acetate and n-butyl acetate. The at least one block copolymer may be any block copolymer and/or combination of block copolymers (e.g., a combination of block copolymers that print to a desired color), wherein in these examples the implemented desired color ranges from violet to blue.

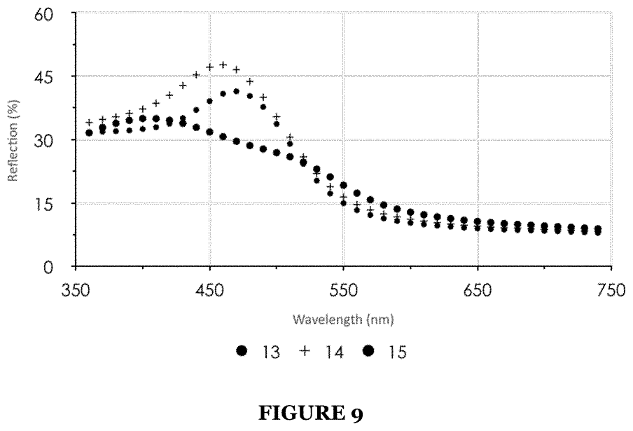

In a first example of the third variation (formulation 13) for a violet color solution, as shown in FIG. 8, the at least one block copolymer concentration is approximately 7.5%-12.5%, the PLA concentration is approximately 2.5%-7.5%, the PS concentration is approximately 2.5%-7.5%, the SAIB concentration is approximately 2.5%-7.5%, the polyvinyl alcohol concentration is approximately 0.01%-5.00%, the curable additive is 2-hydroxyethyl methacrylate with a concentration approximately 2.5%-7.5%, the photoinitiator concentration is approximately 0.01%-5.00%, the ethylene glycol monobutyl ether acetate concentration is approximately 17.5%-22.5%, the n-butyl acetate concentration is approximately 25%-30%, and the H₂O concentration is approximately 17.%-22.5% of the solution. As shown in FIG. 9, this implementation color solution is a precursor to an applied violet color.

In a second example of the third variation (formulation 14) for a blue color solution, as shown in FIG. 8, the at least one block copolymer concentration is approximately 7.5%-12.5%, the PLA concentration is approximately 2.5%-7.5%, the PS concentration is approximately 2.5%-7.5%, the SAIB concentration is approximately 2.5%-7.5%, the polyvinyl alcohol concentration is approximately 0.01%-5.00%, the curable additive is hydroxypropyl methacrylate with a concentration approximately 2.5%-7.5%, the photoinitiator concentration is approximately 0.01%-5.00%, the ethylene glycol monobutyl ether acetate concentration is approximately 17.5%-22.5%, the n-butyl acetate concentration is approximately 25%-30%, and the H₂O concentration is approximately 17.%-22.5% of the solution. As shown in FIG. 9, this implementation color solution is a precursor to an applied blue color.

In a third example of the third variation (formulation 15) for a blue color solution, as shown in FIG. 8, the at least one block copolymer concentration is approximately 7.5%-12.5%, the PLA concentration is approximately 2.5%-7.5%, the PS concentration is approximately 2.5%-7.5%, the SAIB concentration is approximately 2.5%-7.5%, the polyvinyl alcohol concentration is approximately 0.01%-5.00%, the curable additive is THF acrylate with a concentration approximately 2.5%-7.5%, the photoinitiator concentration is approximately 0.01%-5.00%, the ethylene glycol monobutyl ether acetate concentration is approximately 17.5%-22.5%, the n-butyl acetate concentration is approximately 25%-30%, and the H₂O concentration is approximately 17.%-22.5% of the solution. As shown in FIG. 9, this implementation color solution is a precursor to an applied blue color.

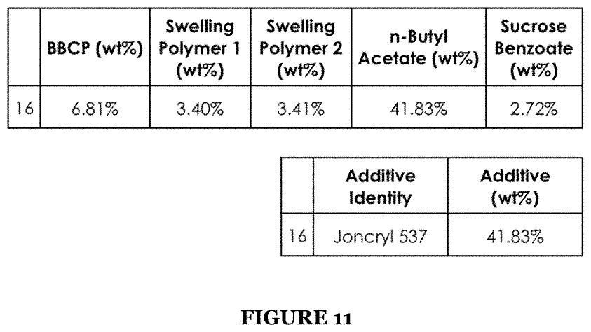

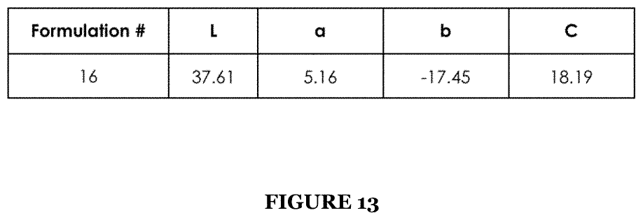

In a fourth variation for a color solution that includes joncryl additive, as shown in FIGS. 11-13, the solution comprises at least one block copolymer, at least one swelling agent, at least one co-binder, at least one surfactant, and at least one solvent, wherein the at least one solvent includes water, contributed from the Joncryl 537 formulated product. As the Joncryl 537 is a commercially available product, this variation, provides a proof of concept that the composition herein may be compatible with commercially available resins meant for waterborne coatings. The at least one swelling agent comprises polylactic acid (PLA) and polystyrene (PS), the at least one co-binder comprises sucrose benzoate, and the at least one solvent comprises: an organic solvent. In these variations, the organic solvent is n-butyl acetate. The at least one block copolymer may be any block copolymer and/or combination of block copolymers (e.g., a combination of block copolymers that print to a desired color), wherein in these examples the implemented desired color is violet.

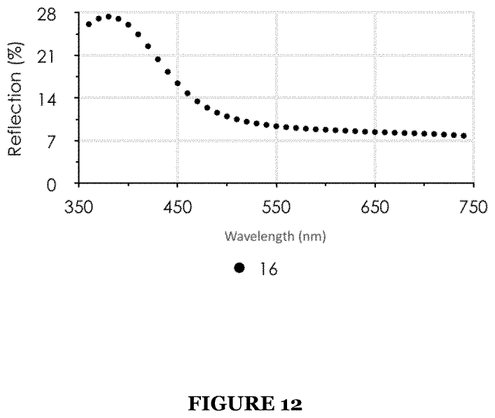

In an example of the fourth variation (formulation 16) for a violet color solution, as shown in FIG. 11, the at least one block copolymer concentration is approximately 5%-10%, the PLA concentration is approximately 0.01%-5.00%, the PS concentration is approximately 0.01%-5.00%, the sucrose benzoate concentration is approximately 0.01%-5.00%, the n-butyl acetate concentration is approximately 40%-45%, and the joncryl additive concentration is approximately 40%-45%. As shown in FIG. 12, this implementation color solution is a precursor to an applied violet color.

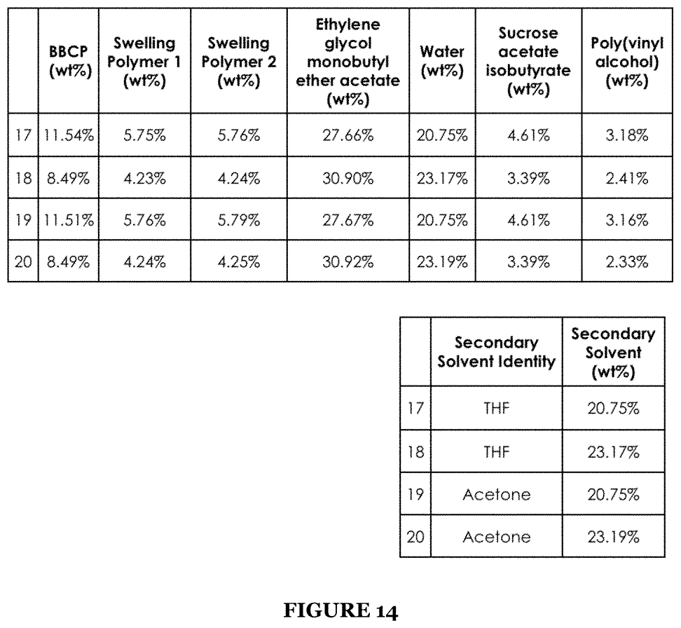

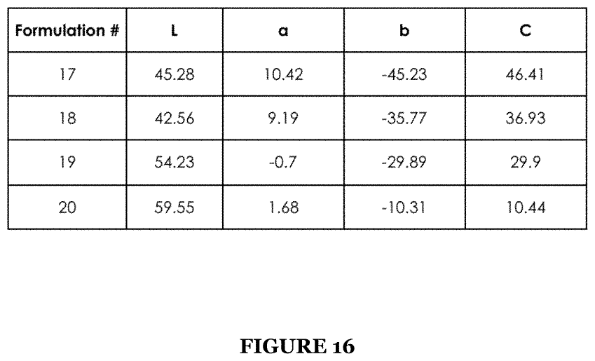

In a fifth variation for a color solution that includes additional water miscible solvents, as shown in FIGS. 14-16, the solution comprises at least one block copolymer, at least one swelling agent, at least one co-binder, and at least one solvent, wherein the at least one solvent includes water and a secondary solvent. The at least one swelling agent comprises polylactic acid (PLA) and polystyrene (PS), the at least one co-binder comprises SAIB-100 and polyvinyl alcohol, the at least one solvent comprises: an organic solvent, an amphipathic solvent, and water. In these variations, the organic solvent is ethylene glycol monobutyl ether acetate and the amphipathic solvent varies per example. The at least one block copolymer may be any block copolymer and/or combination of block copolymers (e.g., a combination of block copolymers that paint to a desired color), wherein in these examples the implemented desired colors range from violet to blue.

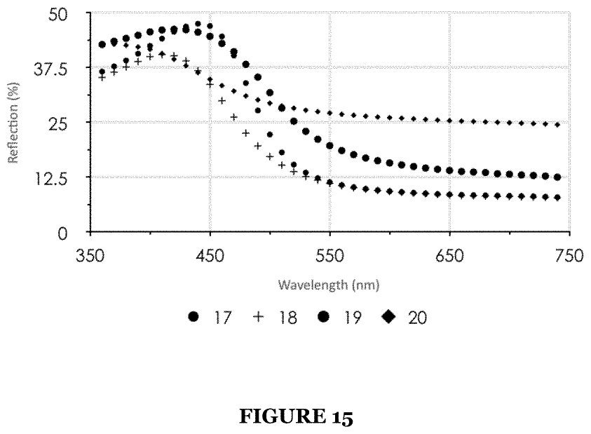

In an example of the fifth variation (formulation 17) for a blue color solution, as shown in FIG. 14, the at least one block copolymer concentration is approximately 7.5%-12.5%, the PLA concentration is approximately 2.5%-7.5%, the PS concentration is approximately 2.5%-7.5%, the SAIB concentration is approximately 2.5%-7.5%, the polyvinyl alcohol concentration is approximately 0.01%-5.00%, the ethylene glycol monobutyl ether acetate concentration is approximately 25%-30%, the secondary solvent is THF with a concentration approximately 17.5%-22.5%, and the H₂O concentration is approximately 17.5%-22.5% of the solution. As shown in FIG. 15, this implementation color solution is a precursor to an applied blue color.

In a second example of the fifth variation (formulation 18) for a violet color solution, as shown in FIG. 14, the at least one block copolymer concentration is approximately 5%-10%, the PLA concentration is approximately 2.5%-7.5%, the PS concentration is approximately 2.5%-7.5%, the SAIB concentration is approximately 0.01%-5.00%, the polyvinyl alcohol concentration is approximately 0.01%-5.00%, the ethylene glycol monobutyl ether acetate concentration is approximately 27.5%-32.5%, the secondary solvent is THF with a concentration approximately 20%-25%, and the H₂O concentration is approximately 17.5%-22.5% of the solution. As shown in FIG. 15, this implementation color solution is a precursor to an applied violet color.

In a third example of the fifth variation (formulation 19) for a blue color solution, as shown in FIG. 14, the at least one block copolymer concentration is approximately 7.5%-12.5%, the PLA concentration is approximately 2.5%-7.5%, the PS concentration is approximately 2.5%-7.5%, the SAIB concentration is approximately 2.5%-7.5%, the polyvinyl alcohol concentration is approximately 2.5%-7.5%, the ethylene glycol monobutyl ether acetate concentration is approximately 25%-30%, the secondary solvent is acetone with a concentration approximately 17.5%-22.5%, and the H₂O concentration is approximately 17.5%-22.5% of the solution. As shown in FIG. 15, this implementation color solution is a precursor to an applied blue color.

In a fourth example of the fifth variation (formulation 20) for a violet color solution, as shown in FIG. 14, the at least one block copolymer concentration is approximately 5%-10%, the PLA concentration is approximately 2.5%-7.5%, the PS concentration is approximately 2.5%-7.5%, the SAIB concentration is approximately 0.01%-5.00%, the polyvinyl alcohol concentration is approximately 0.01%-5.00%, the ethylene glycol monobutyl ether acetate concentration is approximately 27.5%-22.5%, the secondary solvent is acetone with a concentration approximately 20%-25%, and the H₂O concentration is approximately 20%-25% of the solution. As shown in FIG. 15, this implementation color solution is a precursor to an applied violet color.

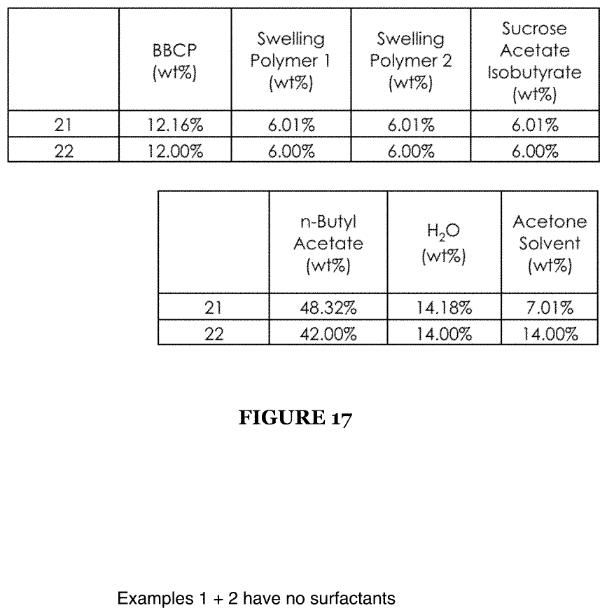

In a sixth variation for a color solution that includes an amphipathic solvent, as shown in FIGS. 17-19, the solution comprises at least one brush block copolymer, at least one swelling agent, at least one co-binder, and at least one solvent, wherein the at least one solvent includes water. The at least one swelling agent comprises polylactic acid (PLA) and polystyrene (PS), the at least one co-binder comprises SAIB-100 (referred to as SAIB), and the at least one solvent comprises: an organic solvent, an amphipathic solvent, and water. In these variations, the organic solvent is n-butyl acetate, and the amphipathic solvent is acetone. The at least one block copolymer may be any block copolymer and/or combination of block copolymers (e.g., a combination of block copolymers that print to a desired color), wherein in these examples the implemented desired color is blue.

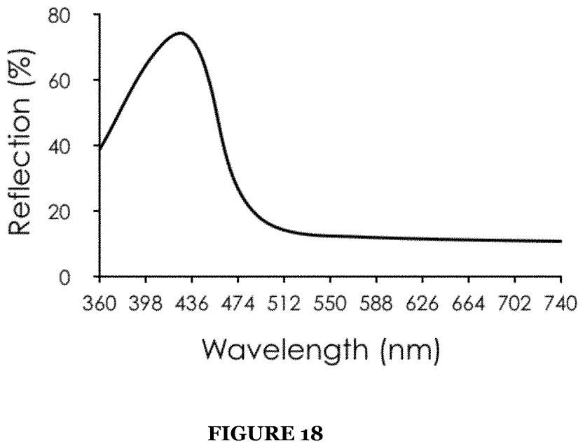

In a first example of the sixth variation (formulation 21) for a blue color solution, as shown in FIG. 17, the at least one block copolymer concentration is approximately 10%-15%, the PLA concentration is approximately 2.5%-7.5%, the PS concentration is approximately 2.5%-7.5%, and the SAIB concentration is approximately 2.5%-7.5% of the solution; the n-butyl acetate concentration is approximately 45%-50%, the H₂O concentration is approximately 10%-15%, and the acetone concentration is approximately 5%-10% of the solution. As shown in FIG. 18, this implementation color solution is a precursor to an applied blue color.

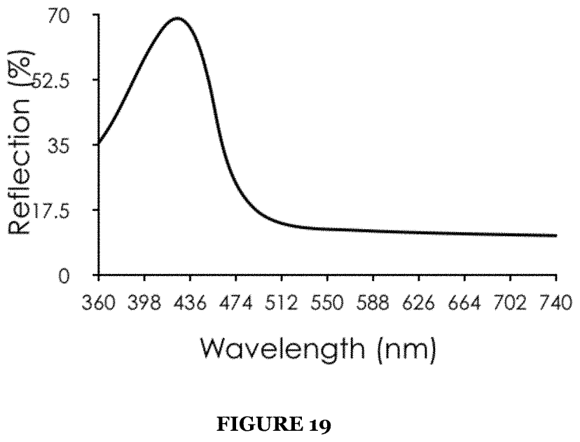

In a second example of the sixth variation (formulation 22) for a blue color solution, as shown in FIG. 17, the at least one block copolymer concentration is approximately 10%-15%, the PLA concentration is approximately 2.5%-7.5%, the PS concentration is approximately 2.5%-7.5%, and the SAIB concentration is approximately 2.5%-7.5% of the solution; the n-butyl acetate concentration is approximately 40%-45%, the H₂O concentration is approximately 10%-15%, and the acetone concentration is approximately 5%-10% of the solution. As shown in FIG. 19, this implementation color solution is a precursor to an applied blue color.

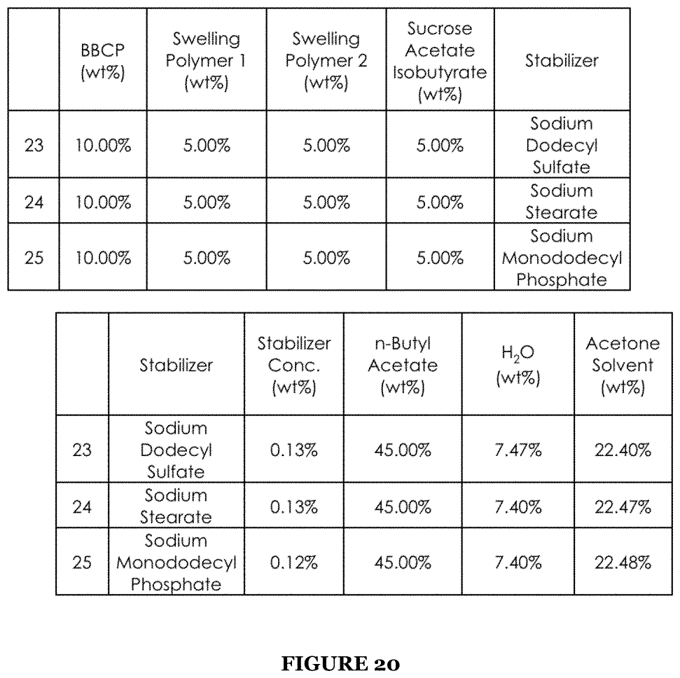

In a seventh variation for a color solution that further includes a surfactant, as shown in FIGS. 20-23, the solution comprises at least one block copolymer, at least one swelling agent, at least one co-binder, at least one stabilizer comprising a surfactant, and at least one solvent, wherein the at least one solvent includes water. The at least one swelling agent comprises polylactic acid (PLA) and polystyrene (PS), the at least one co-binder comprises SAIB-100 (referred to as SAIB), the at least one stabilizer comprises sodium dodecyl sulfate, sodium stearate, and/or sodium monododecyl phosphate, and the at least one solvent comprises: an organic solvent, an amphipathic solvent, and water. In these variations, the organic solvent is n-butyl acetate, and the amphipathic solvent is acetone. The at least one block copolymer may be any block copolymer and/or combination of block copolymers (e.g., a combination of block copolymers that print to a desired color), wherein in these examples the implemented desired color is blue.

In one example of the seventh variation (formulation 23) for a blue color solution, as shown in FIG. 20, the at least one block copolymer concentration is approximately 7.5%-12.5%, the PLA concentration is approximately 2.5%-7.5%, the PS concentration is approximately 2.5%-7.5%, the SAIB concentration is approximately 2.5%-7.5%, and the sodium dodecyl sulfate concentration is approximately 0.05%-0.20% of the solution; the n-butyl acetate concentration is approximately 40%-50%, the H₂O concentration is approximately 5%-10%, and the acetone concentration is approximately 20%-25% of the solution. As shown in FIG. 21, this implementation color solution is a precursor to an applied blue color.

In a second example of the seventh variation for a blue color solution, as shown in FIG. 20, the at least one block copolymer concentration is approximately 7.5%-12.5%, the PLA concentration is approximately 2.5%-7.5%, the PS concentration is approximately 2.5%-7.5%, the SAIB concentration is approximately 2.5%-7.5%, and the sodium stearate concentration is approximately 0.05%-0.20% of the solution; the n-butyl acetate concentration is approximately 40%-50%, the H₂O concentration is approximately 5%-10%, and the acetone concentration is approximately 20%-25% of the solution. As shown in FIG. 22, this implementation color solution is a precursor to an applied blue color.

In a third example of the seventh variation for a blue color solution, as shown in FIG. 20, the at least one block copolymer concentration is approximately 7.5%-12.5%, the PLA concentration is approximately 2.5%-7.5%, the PS concentration is approximately 2.5%-7.5%, the SAIB concentration is approximately 2.5%-7.5%, and the sodium monododecyl phosphate concentration is approximately 0.05%-0.20% of the solution; the n-butyl acetate concentration is approximately 40%-50%, the H₂O concentration is approximately 5%-10%, and the acetone concentration is approximately 20%-25% of the solution. As shown in FIG. 22, this implementation color solution is a precursor to an applied blue color.

In an eighth variation for a color solution, as shown in FIGS. 24-26, the solution comprises at least one block copolymer, at least one swelling agent, at least one co-binder, at least one surfactant, and at least one solvent, wherein the at least one solvent includes water. The at least one swelling agent comprises polylactic acid (PLA) and polystyrene (PS), the at least one co-binder comprises SAIB-100, the at least one surfactant comprises sodium sulfobetaine-18, and the at least one solvent comprises: an organic solvent, an amphipathic solvent, and water. In these variations, the organic solvent is n-butyl acetate, and the amphipathic solvent is acetone. The at least one block copolymer may be any block copolymer and/or combination of block copolymers (e.g., a combination of block copolymers that print to a desired color), wherein in these examples the implemented desired color is blue.

In a first example of the eight variation (formulation 25) for a blue color solution, as shown in FIG. 24, the at least one block copolymer concentration is approximately 7.5%-12.5%, the PLA concentration is approximately 2.5%-7.5%, the PS concentration is approximately 2.5%-7.5%, the SAIB concentration is approximately 2.5%-7.5%, and the sulfobetaine-18 concentration is approximately 0.05%-0.25% of the solution; the n-butyl acetate concentration is approximately 40%-50%, the H₂O concentration is approximately 15%-20%, and the acetone concentration is approximately 10%-15% of the solution. As shown in FIG. 25, this implementation color solution is a precursor to an applied blue color.

In a second example of the eighth variation for a blue color solution, as shown in FIG. 24, the at least one block copolymer concentration is approximately 7.5%-12.5%, the PLA concentration is approximately 2.5%-7.5%, the PS concentration is approximately 2.5%-7.5%, the SAIB concentration is approximately 2.5%-7.5%, and the sulfobetaine-18 concentration is approximately 0.05%-0.25% of the solution; the n-butyl acetate concentration is approximately 35%-45%, the H₂O concentration is approximately 12.5%-17.5%, and the acetone concentration is approximately 20%-25% of the solution. As shown in FIG. 25, this implementation color solution is a precursor to an applied blue color. As described previously, the at least one block copolymer included in the color solution may be implementation specific and may be varied as desired. Herein several brush block copolymers may be used individually, together, or as part of a separate mixture of the at least one block copolymer. Example brush block copolymers may have a number average molecular weight (Mn) in the range of 400 kDa to 4,000 kDa, more preferably in the range of 500 kDa to 3,000 kDa, and even more preferably in the range 600 kDa to 2,500 kDa. The brush block copolymer (BBCP1) may have a number average molecular weight (Mn) of 799.4 kDa and a weight average molecular weight (Mw) of 850.9 kDa, with a polydispersity index (PDI) of 1.064. Formulations containing the BBCPs preferably form reflective coatings in the wavelength range 200 nm to 1600 nm. As desired per implementation, these sample brush block copolymers may be incorporated as part of the previously described example color solutions. The sample brush block copolymers may be incorporated as single brush block copolymers in the color solution, or as a mixture of two or more brush block copolymers; wherein the ratio of the brush block copolymers may set the color solution color. In all presented examples the at least one block copolymer comprises BBCP1. Alternatively, any other desired block polymer may be implemented.

### 3. Method

As shown in FIG. 27, a method for preparing and applying a block polymer-based aqueous color solution includes: preparing a color solution S110 and depositing the color solution S130. Preparing the color solution S110 may include adjusting the color solution for appropriate application, thereby: setting the color solution base colors, and setting the color solution physical properties (e.g., viscosity, solution dry time, temperature tolerance, hydrophobicity).

In some variations, the method may include loading the color solution S120. Loading the color solution may comprise implementation specific steps dependent on the implemented color solution (e.g., architectural, cosmetic, automotive, paper print, etc. or) and the type of implemented applicator (e.g., brush, spray, hand), Loading the color solution may include mixing the color solution.

In some variations, the method may include implementing a post-processing step for further print modifications and/or improvements. In these variations the method may include: post-processing the print S140.

The method functions to prepare and print a structural color design on a desired target object (i.e., substrate) using an aqueous, block polymer photonic crystal forming, color solution. The method enables multiple implementations of multi-color printing. That is, the method may enable both premixed colors to be implemented, and/or layering of colors. Using premixed colors comprises premixing a desired color prior to printing the desired color. Layering colors, may include applying multi-pass color layers to obtain a desired color. The method may be preferably implemented with the aqueous structural color solution composition as described above but may be generally implemented for any photonic crystal forming solution.

The method may be applicable for use with any painting/printing device and/or painting/printing applicator that enables application of an aqueous solution to a substrate. The method may be particularly applicable for coloring in biologically sensitive markets (e.g., cosmetics), where the aqueous composition of the color solution may provide a significantly reduced toxicity as compared to latex-based paints. The method may be implemented for any general painting/printing application, wherein application specific steps may be incorporated into the method.

By leveraging a structural color-based solution, the method may provide: additive coloring steps and/or hybrid (additive/subtractive) coloring steps; wherein one type of coloring or a combination of coloring methods may be used to color a substrate. For example, the method may enable an additive printing variation (e.g., using the photonic crystal forming color solutions) with a previously existing set of subtractive colorations (e.g., traditional CMYK inks). That is, the method may enable a structural coloration to be implemented in combination with a pigment or dye coloration. The method coloration may be implemented simultaneously with the pigment or dye coloration (e.g., through premixing), or may be implemented afterwards (e.g., through layering photonic crystal forming ink solutions over or under the pigment or dye coloration layer).

As part of any painting/printing implementation, the method may be implemented for color determination prior to (i.e., premix), and/or after (postmix) application of the color solution to a substrate. For premix color, the desired color for an application may be mixed prior to applying the aqueous solution to a substrate. In variations that include premixed color, loading the color solution S120 may further comprise mixing the color solution to the appropriate color. In some variations for premixed color, preparing a color solution S110 may comprise obtaining multiple color solutions, wherein loading the color solution S120 would then comprise mixing the multiple color solutions.

For post mix color, the desired color may be achieved by mixing/layering colors on the substrate (i.e., achieve the desired color after painting/printing). That is, the color solution is applied with a fixed set of colors, and the desired color is achieved by applications of multiple colors onto the substrate. Colors are thus layered (or mixed), on the substrate, until the desired color is achieved. Postmix color mixing may comprise either additive (e.g., RGB), subtractive coloring (e.g., CMYK), and/or some hybrid combination of additive and subtractive coloring. For postmix color implementations, depositing the color solution S130 may include multiple painting passes with the color solution, and/or depositing multiple color solutions simultaneously to achieve the desired design, brightness, and color thickness/opacity, with the desired color(s). For additive postmix color mixing, multiple photonic crystal forming inks may be enabled/allowed to mix on the substrate to achieve the desired color. For hybrid (additive and subtractive) postmix color, multiple photonic crystal forming inks and pigmented inks may be enabled/allowed to mix (or layered) on the substrate to achieve the desired color. There may be a drying time between each pass, such that the color solutions dry on top of each other to provide the desired hybrid coloring.

Block S110, which includes preparing a color solution, functions to set up and/or create an aqueous color solution that when deposited on a substrate, forms a film of photonic crystals, that reflect (appear) a desired color.

Block S110, which includes preparing a color solution, functions to prepare a photonic crystal forming color solution. That is block S110, functions to prepare an appropriate color solution mixture with the necessary parameters for functionality with a painting/printing implementation. Preparing a color solution S110 may be implementation specific. In some variations, block S110 may include obtaining or creating a color solution with the necessary properties for the specific implementation (e.g., both application and applicator). Examples of necessary properties may include: appropriate polymer concentration, appropriate viscosity, temperature thresholds for functionality, droplet drying time, color solution stability (e.g., different time scales for nail polish versus architectural), organic solvent concentration (e.g., to minimize volatile organic compounds) and or any other necessary property. For example, for an inkjet implementation, the color solution must have a sufficiently low viscosity as compared to the frequency of the inkjet jetting. For an architectural implementation, the organic solvent threshold must be reduced for a safe product for use. For a cosmetic implementation, the color solution the water concentration may be increased in addition to a reduced concentration of organic solvents.

In some variations, preparing a color solution S110 comprises creating an aqueous color solution as any of the color solution variations described in the system above. In these variations, preparing a color solution S110 may include mixing a block copolymer mixture of desired color with at least one solvent comprising water. Dependent on the implementation preparing a color solution S110 may additionally include mixing linear polymers, co-binders, surfactants, additives, amphipathic solvents, water-insoluble organic solvents, and water-soluble organic solvents.

In many variations, mixing components of the color solution may be order specific, wherein the color brightness, shade, opacity, and other factors may be affected by the order of mixing. For a given color solution (i.e., given recipe of components), the order of mixing may be dependent on the order that hydrophilic compounds and solvents (i.e., hydrophilic components), hydrophobic compounds and solvents (i.e., hydrophobic components), and amphipathic compounds and solvents (i.e., amphipathic components) are added.

In a first method, mixing components of the color solution includes initially mixing the hydrophilic compounds with the hydrophilic solvents (including water), mixing the amphipathic components with the amphipathic solvents (and mixing the hydrophobic components with the hydrophobic solvents. The amphipathic components and the hydrophobic components are then combined and added to the hydrophilic components.

In a second method, mixing components of the color solution includes initially mixing the hydrophilic compounds with the hydrophilic solvents (including water), mixing the amphipathic components with the amphipathic solvents (and mixing the hydrophobic components with the hydrophobic solvents. The hydrophilic components are then mixed with the amphipathic components, and then the hydrophobic components are added to the mixture.

In a third method, mixing components of the color solution includes initially mixing the hydrophilic compounds with the hydrophilic solvents (including water), mixing the amphipathic components with the amphipathic solvents (and mixing the hydrophobic components with the hydrophobic solvents. The hydrophilic components are mixed with the amphipathic components. Once the hydrophilic components and the amphipathic components are mixed, they are then added to the hydrophobic components.

In a fourth method, mixing components of the color solution includes initially mixing the hydrophilic compounds with the hydrophilic solvents (including water), mixing the amphipathic components with the amphipathic solvents (and mixing the hydrophobic components with the hydrophobic solvents. The amphipathic components are added and mixed with the hydrophobic components. Once mixed, the hydrophilic components are then added.

Dependent on the type, and color, of the painting/printing implementation, preparing a color solution S110 may comprise preparing multiple color solutions (e.g., different reflected wavelengths). In this manner, preparing a color solution S110, may additionally include setting the color solution base colors. Setting the color solution base colors may function to enable different types of coloring (e.g., additive and/or hybrid additive/subtractive printing) and set the parameters for a printing implementation. For example, for an additive printing implementation, obtaining three: red, blue, and green base color ink solutions, may set the limit for the printed color gamut to the RGB gamut. Preparing a color solution S110 may similarly include setting base color solutions targeting reflected wavelengths outside of the visible spectrum (e.g., ultraviolet or infrared).

For a premix example, preparing a color solution S110 may comprise obtaining/creating color solutions that would form photonic crystals reflecting a desired wavelength range. In one full visible spectrum range implementation, preparing a color solution S110 may comprise preparing a color solution that corresponds to photonic crystals with reflection at a wavelength of approximately 400 nm and a second ink solution that corresponds to photonic crystals with reflection at a wavelength of approximately 750 nm. In one ultraviolet spectrum range implementation, preparing a color solution S110 may comprise creating/obtaining a color solution that corresponds to photonic crystals with reflection at a wavelength range of approximately 200 nm to 400 nm. In one near-infrared range implementation, preparing a color solution S110 may comprise creating/obtaining a color solution that corresponds to photonic crystals with reflection at a wavelength range of approximately 750 nm to 2000 nm.

Block S120, which includes loading the color solution, functions to prep the color solution and or color solutions for use (e.g., painting, printing, spraying, etc.). Loading the color solution S120 may vary depending on the implementation. For example, for inkjet printing, loading the color solution S120 may include heating the color solution in ink reservoirs. For a premix color implementation, the loading the color solution S120 may include mixing the color solution to the desired color. In multi-pass implementations (e.g., multi-pass printing), loading the color solution S120 may be called between each printing pass (e.g., where a new color is loaded from an ink reservoir to the printer head).

As part of an ink jet implementation, loading the color solution S120 may include heating the color (ink) solution. Heating the ink solution may function to alter the ink solution properties for printing. Heating the ink solution may be specific to the inkjet head, such that ink does not clog the head, and droplets released by jetting of the ink solution are of a desired volume and velocity.

As part of premix color implementations, loading the color solution S120 may include mixing multiple color solutions. That is, for desired premix color, loading the color solution S120 may include: determining the base color combinations and their respective ratios for creating the desired paint/print color and then combining and mixing the color solutions in the appropriate ratios to achieve the desired paint/print color. This preprint mixing may vary dependent on the system implementation. In many variations, this mixing uses the already implemented mixing components of the system for mixing. For printing, common current printer technology does not incorporate a premix color, additional components may need to be incorporated mixing multiple color solutions. Any general mixing techniques may be used. Examples of mixing techniques that may be used for mixing multiple color solutions include: mechanical mixing, magnetic force mixing, high shear mixing, sonication, centrifugal mixing, or planetary mixing.

Block S130, which includes depositing the color solution, functions to “print” a desired pattern on the target material (substrate). As used herein, paint/painting may refer to any form of deposition of the color solution on the desired abstract (e.g., painting a wall with a brush, applying makeup with a brush applicator, imprinting onto paper using a printer, etc.).

In some variations (e.g., in premix color variations), depositing the color solution S130 may comprise only a single pass, wherein the desired pattern is deposited with the desired color(s) in one “go”. For multiple color implementations, mixing multiple color solutions may be called multiple times for each color necessary for depositing the color solution S130.

In some variations (e.g., postmix color), depositing the color solution S130, may be called multiple times. In these variations, one or multiple, colors may be printed in one printing pass. Dependent on implementation, the color solution may then be allowed to dry prior to printing an additional pass.

Additionally or alternatively, the method may include post print additive coloring. For additive post print coloring, depositing the color solution S130 may print either a single color or multiple colors simultaneously. Additional printing passes may deposit different color solutions to achieve the desired post print color. As a distinction to subtractive post print coloring, additional passes are printed prior to the solution drying, thereby creating a single film on the substrate with the desired post print color. In some variations, “mixing” techniques may be incorporated to better mix the deposited color solution on the substrate. Examples of post print mixing techniques that can be incorporated include: inducing mixing through a magnetic field or electrical stimulus, heating the ink solution, or sonication.

In some variations, the method may include post-processing the print S140. Post-processing the print S140 may function to modify the print after the color solution has been applied to the substrate. Dependent on the implementation, post-processing the print S140 may occur after: a single printing pass; directly after each printing pass, after some specific printing passes, or after all printing passes. Additionally, or alternatively, post-processing the print S140 may occur after depositing the color solution S130 has completed, or any variations within depositing the color solution. Post-processing may include drying the print, mixing multiple print passes, stabilizing the print, cross-linking the print, curing the print, or enhancing or altering the print in some other manner. In some variations, post-processing the print may include printing a protective overprint varnish, clear coat, or some other surface material on the print.

In some variations, post-processing the print S140 may include ambient drying or actively drying the print (e.g., by application of an infrared/thermal or UV lamp). Actively drying the print may quickly dry the ink solution to enable efficient multi-pass printing or enable efficient implementation of other types of post-processing. For multi-pass implementations, actively drying the print may partially or fully dry the ink solution after each pass.

In some variations, post-processing the print S140 may include mixing multiple print passes (e.g., for additive postmix coloring). This mixing may be incorporated through agitation (e.g., sonication) or mechanical mixing of the multiple print passes. Mixing of multiple print passes preferably occurs directly after printing a pass to prevent the multiple passes from drying prior to combining into a single color.

In another variation, post-processing the print S140 includes stabilizing the print. Stabilizing the print may help better protect the print from environmental and other external factors. Stabilizing the print may include applying a protective coating (e.g., application of a clear resin). In some implementations, stabilizing the print may enable layering of color solutions such that the colors do not mix. In some implementations, stabilizing the print may involve inducing chemical transformation within the print.

In another variation, post-processing the print S140 may include curing the print. Curing the print may function to control color angle dependency of the print. The aqueous color solution once dried may form an unorganized (well mixed) photonic crystal structure that reflects light identically from all directions. Curing the print may organize the dried photonic crystal structure such that the colored surface appears differently dependent on angle of observation.

In some variations the method may additionally enable modification of the steps to enable specific operating modes. Examples of possible implemented operating modes include: a print quality operating mode (e.g., high resolution printing versus an ink-saver mode), a speed operating mode (e.g., high through-put speed versus slower high-quality printing), and color operating mode (e.g. color versus black/white printing, or greyscale printing).

In some variations multiple different curing steps may be used, in different orders. These different curing steps include thermal, air dry, near infrared, or ultraviolet curing. The use of different combinations in different orders may give rise to different colors or angle dependence.

As mentioned above, the method may incorporate many types of painting/printing steps for specific use cases. For example, the method may be applicable for use with inkjet printing, wherein loading the color solution S120 further comprises heating the color solution. The method may be generally used with any type of print method with minor changes to implementation steps dependent on the printing method. As part of an inkjet implementation, the method may be implemented for both continuous inkjet (CIJ) with print frequencies up to 80-10 kHz and drop-on-demand inkjet (DOD) with print frequencies up to 10-50 kHz, and drop speeds up to 4-10 m/s, wherein the method may be implemented for thermal DOD, piezoelectric DOD, MEMS printing, and any other type of inkjet printing. Additionally, the method may be implemented with non-inkjet forms of such as: screen printing, flexoprinting, roto-gravure printing, and offset printing.

As part of any printing type, the method may be implemented for premixed color printing, and/or postmix color printing. For premixed printing, the desired color for a print may be premixed, such that through a single pass the desired color is directly printed. That is, the color solution is premixed prior to color generation. Thus, loading the color solution S120 may further comprise mixing the color solution to the appropriate color. In some variations for premixed color printing, preparing a color solution S110 may comprise obtaining multiple color solutions, wherein loading the color solution S120 would then comprise mixing the multiple color solutions.

As an example of a non-printing application, the method may be applicable for use in spray deposition. Spray deposition can either be performed in a DIY fashion by the end user from forms such as aerosol, hand-pump, or airbrush, or performed at the OEM level from forms such as air atomized automotive spray guns, or rotary bell application. Air atomized spray guns can be reduced pressure or high-volume low pressure.

The method may also be particularly useful for cosmetic implementation and cosmetic application. As part of a cosmetic implementation, preparing a color solution S110 may comprise obtaining a set of base colors of the appropriate type of cosmetic (e.g., nail polish). These base colors may then be premixed to a desired color as part of loading the color solution S120, or different colors may be obtained by having multiple passes of depositing the color solution S130. Additionally, in the example of nail polish, a clear coat may be applied on top of the structural color layer. Similarly, a pigmented layer may be applied first, residing underneath the photonic crystal layer.

The method may also be particularly applicable for architectural paint. As part of an architectural paint implementation, preparing a color solution S110 may further comprise: obtaining a set of base colors, adding stabilizers and organic solvents (e.g., to improve the durability of the color solution), adding solvents to obtain the desired paint viscosity (e.g., for paint brush or spray paint); and post-processing the print S140 may additionally include adding a water proof coating or thermal energy input to induce a curing mechanism.

As mentioned above, the method may leverage the properties of aqueous structural color solutions to construct color designs through additive or hybrid coloring; where additive coloring may be incorporated prior to, or after printing onto a substrate, and hybrid coloring may be incorporated after printing by layering colors. The method may additionally incorporate any combination of: premix additive coloring, post print additive coloring, and postmix hybrid coloring.

For example, the system may include obtaining two color solutions initially. Through premix additive coloring the two-color solutions may be be combined to form color solutions for red, green, and blue. These colors are then printed and postmix coloring is used to create designs in the RGB gamut using the red, green, and blue aqueous photonic crystal forming solutions.

The method may be highly implementation specific and may include many variations dependent on the implemented printing system and the desired method of coloring. In one variation, a printing method for structural ink may include: receiving at a printer system, at least one reservoir of photonic crystal forming ink, wherein the photonic crystal ink comprises a solution that once printed onto a substrate, dries into a photonic crystal film of a designated color; loading the color solution, thereby preparing the photonic crystal forming color for printing; and printing the color solution, thereby depositing a first layer photonic crystal film. Dependent on implementation, the method may further include post-processing the photonic crystal film. In one variation, post-processing the photonic crystal film includes adding a protective clear coat or overprint varnish onto the photonic crystal film. In another variation, post-processing the photonic crystal film includes actively drying the photonic crystal film.

The method may be particularly suited for premix additive color mixing. In these variations, a printing method for structural color may include: receiving at a printer system, at least one reservoir of photonic crystal forming ink, wherein the at least one reservoir of photonic crystal forming color includes at least two reservoirs of photonic crystal forming color solutions; loading the color solution, comprising mixing the at least two reservoirs of photonic crystal forming ink to achieve a premix desired color solution and preparing the desired color solution for printing; depositing the color solution, thereby depositing a first layer photonic crystal film corresponding to the preprint desired color; and post-processing the photonic crystal film.

Dependent on implementation for premix additive color mixing, the method may incorporate coloring using a minimum of two reservoirs. In a two-color example of the premix additive coloring, the at least two reservoirs of photonic crystal color solutions correspond to two reservoirs, a first photonic crystal color solution and a second photonic crystal color solution and the mixing the two reservoirs of photonic crystal color solutions comprise setting the premix desired color by the ratio of the first photonic crystal color solution and the second photonic crystal color solution.

The method additionally allows premix coloring using more conventional three-color additive coloring (e.g., RGB color gamut). For example, in the three reservoir coloring, the at least two reservoirs of photonic crystal color solutions comprises three reservoirs of photonic crystal color solutions: a first photonic crystal color solution (e.g., corresponding to a red color solution), a second photonic crystal color solution (e.g., corresponding to a green color solution), and a third photonic crystal color solution (e.g., corresponding to a blue color solution) and the mixing the three reservoirs of photonic crystal color solution comprises setting the premix desired color by the ratio of the first photonic crystal color solution, the second photonic crystal color solution, and the third photonic crystal color solution.

The method also allows itself to be incorporated for postmix coloring. In a postmix coloring variation, a coloring method for structural color solution may include: receiving at a printer system, at least one reservoir of photonic crystal forming color solution, wherein the at least one reservoir of photonic crystal forming color solution comprises receiving at least two reservoirs of photonic crystal forming color solutions; loading the color solution, comprising loading a single photonic crystal forming color solution at a time; depositing the color solution, comprising printing multiple passes over a substrate with a different photonic color solution; and post-processing the photonic crystal film.

As an example of an additive postmix color, printing multiple passes over a substrate includes mixing the printed color solutions, such that once dried, only a single layer film of the determined postmix color is deposited on the substrate. As part of a “traditional” RGB implementation for postmix coloring, the at least two reservoirs of photonic crystal ink may comprise three reservoirs of photonic crystal color solutions: a first photonic crystal color solution corresponding to a red color solution, a second photonic crystal color solution corresponding to a green color solution, and a third photonic crystal color solution corresponding to a blue color solution and depositing the color solution, comprising: printing the calculated amount of the first photonic crystal color solution, printing the calculated amount of the second photonic crystal color solution, printing the calculated amount of the third photonic crystal color solution, and mixing the photonic crystal color solutions.

The method may also allow itself to be incorporated for hybrid additive/subtractive printing. For a hybrid additive/subtractive postmix color, depositing the color solution may comprise multiple passes, where for each printed pass, printing with a different photonic color solution or with a different subtractive color solution. Post processing the photonic crystal film may then include drying the photonic crystal film and/or drying the subtractive color ink film, such that once completed, a multi-layer film is deposited on the substrate corresponding to the determined post print color.

Additionally in some variations, the at least two reservoirs of the of photonic crystal color solutions may comprise four reservoirs of color solutions: a first photonic crystal color solution corresponding to a red color solution, a second photonic crystal color solution corresponding to a green color solution, a third photonic crystal color solution corresponding to a blue color solution and a fourth color solution subtractive color solution (e.g., a black/other color pigment or dye). In this variation, depositing the color solution, may then include: printing the calculated amount of the first photonic crystal color solution, printing the calculated amount of the second photonic crystal color solution, printing the calculated amount of the third photonic crystal color solution, printing the calculated amount of the fourth subtractive color solution; and post-processing the photonic crystal film comprises: drying the first photonic crystal ink layer, drying the second photonic crystal ink layer, drying the third photonic crystal ink layer, and drying the subtractive color ink layer ink layer. In alternative variations, the incorporated subtractive color solution may comprise an entire subtractive color gamut (e.g., CMYK gamut).

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A composition for an aqueous color solution comprising:
at least one block copolymer; and
at least one solvent, comprising an organic solvent and water,
wherein water, comprises at least 10%, by weight, of the entire composition.

2. The composition of claim 1, wherein the at least one block copolymer comprises at least one brush block copolymer.

3. The composition of claim 2, wherein the solvent further comprises an amphipathic solvent.

4. The composition of claim 3, wherein the amphipathic solvent consists of at least one of the following compounds: acetone, 1-methoxy-2-propanol, benzyl alcohol, or tetrahydrofuran.

5. The composition of claim 3, wherein the amphipathic solvent consists of at least one from the following list: 1-butyrolactone, ethanol, methanol, ethylene glycol mono-n-propyl ether, diethylene glycol monoethyl ether, ethylene glycol monomethyl ether, ethylene glycol monoisopropyl ether, diethylene glycol monomethyl ether, triethylene glycol monomethyl ether, ethylene glycol monoethyl ether, diethylene glycol monopropyl ether, ethylene glycol monobenzyl ether, acetonitrile, diethylene glycol monobutyl ether, 1,3-dioxolane, propylene glycol monomethyl ether, propylene glycol monophenyl ether, propylene glycol monoethyl ether, dipropylene glycol mono n-propyl ether, ethylene glycol monomethyl ether acetate, propylene glycol monoisopropyl ether, dipropylene glycol mono n-butyl ether, diethylene glycol hexyl ether, ethylene glycol mono t-butyl ether, propylene glycol mono t-butyl ether, dipropylene glycol methyl ether, ethylene glycol mono n-hexyl ether, diethylene glycol divinyl ether, propylene glycol monomethyl ether acetate, tripropylene glycol monomethyl ether, diethylene glycol methyl t-butyl ether, ethylene glycol monoethyl ether acetate, diethylene glycol monoethyl ether acetate, methyl ethyl ketone, ethylene glycol butyl ether acetate, propylene glycol monoethyl ether acetate, ethylene glycol mono 2-ethylhexyl ether, ethylene glycol monoisobutyl ether, propylene glycol monoisobutyl ether, dipropylene glycol monomethyl ether acetate, propylene glycol monobutyl ether, ethylene glycol methyl t-butyl ether, diethylene glycol butyl ether acetate, ethylene glycol dimethyl ether, diethylene glycol diethyl ether, triethylene glycol monooleyl ether, ethylene glycol di-t-butyl ether, ethylene glycol diethyl ether, ethylene glycol butyl methyl ether, diethylene glycol dibutyl ether, ethylene glycol butyl ethyl ether, ethylene glycol dibutyl ether, 1,2-hexanediol, and glycerin.

6. The composition of claim 3, further comprising at least one co-binder.

7. The composition of claim 6, wherein the at least one co-binder includes crosslinking functional groups.

8. The composition of claim 7, wherein the at least one co-binder comprises sucrose acetate iso-butyrate (SAIB-100).

9. The composition of claim 8, wherein the at least one co-binder further comprises polyvinyl alcohol.

10. The composition of claim 6, wherein the at least one co-binder comprises sucrose benzoate.

11. The composition of claim 3, further comprising at least one swelling agent.

12. The composition of claim 11, wherein the swelling agent includes crosslinking functional groups.

13. The composition of claim 3, wherein the composition further includes a set of additives, wherein the set of additives consists of at least one additive from the following list of additives: stabilizing additives, UV absorbers, antioxidants, hindered amine light stabilizers.

14. The composition of claim 33, wherein the composition further includes a set of additives that include a surfactant.

15. The composition of claim 3, wherein the composition has a precursor state prior to the addition of the at least one solvent, such that with addition of the at least one solvent, becomes a functional aqueous color forming solution.

16. The system of claim 14, wherein the precursor state comprises a dry state, wherein the dry components comprise at least one block copolymer, at least one co-binder, and at least one surfactant.

17. The system of claim 15, wherein the precursor dry state is brought to an active state, by initially mixing the dry state composition with an organic, or amphipathic, solvent.

18. The system of claim 14, wherein the precursor state comprises a highly concentrated form of the composition.

19. A method for preparing and applying a block polymer-based aqueous color solution comprising:
preparing a color solution, wherein the color solution comprises an aqueous solution that forms a photonic crystal film once deposited onto a substrate;
loading the color solution;
depositing the color solution; and
post-processing the print.
